(19) United States
(12) Patent Application Publication
(10) Pub. No.: US 2002/0013739 A1
(43) Pub. Date: Jan. 31, 2002

(54) Apparatus and method for providing anonymous shipping services

(76) Inventors: Stephen Christopher O'Donnell, St. James, NY (US); Lori Jeanne Browning, East Islip, NY (US); Kevin John O'Donnell, Sound Beach, NY (US)

Correspondence Address: STEPHEN C. O'DONNELL, 21 PARK AVENUE, ST. JAMES, NY, 11780, US

(21) Appl. No.: 09/885,696

(22) Filed: Jun. 20, 2001

Related U.S. Application Data
(60) Provisional application No. 60/222,466, filed on Jul. 28, 2000.

(51) Int. Cl. G06F 17/60; H04K 1/00; H04L 9/00

(52) U.S. Cl. 705/26; 705/74

(57) ABSTRACT

An apparatus and method for facilitating an anonymous shipment, including a memory device for storing information regarding the identity and shipping address for at least one individual, a receiver for receiving an order for at least one of a good and a service, a processor for processing the order for the at least one of a good and a service, wherein the processor generates an order message, wherein the order message contains a shipping message containing at least one of an anonymous shipping address information, an encoded shipping address information, an encrypted shipping address information, and a disguised shipping address information, wherein the shipping message conceals the address of an individual who at least one of placed the order and is to receive the shipment, and a transmitter for transmitting the order message to a provider of at least one of goods and services for order fulfillment.

### RELATED APPLICATIONS

This application claims the benefit of priority of U.S. Provisional Patent Application Ser. No. 60/222,466, filed Jul. 28, 2000, and entitled “APPARATUS AND METHOD FOR PROVIDING ANONYMOUS SHIPPING SERVICES”, the subject matter of which is hereby incorporated by reference herein. This application also claims the benefit of priority of U.S. Provisional Patent Application Ser. No. 60/912,563, filed Jun. 20, 2000, and entitled “APPARATUS AND METHOD FOR FACILITATING AN ANONYMOUS SHIPMENT AND/OR FOR FACILITATING ANONYMOUS TRANSACTIONS AND/OR ANONYMOUS COMMUNICATIONS”, the subject matter of which is hereby incorporated by reference herein.

### FIELD OF THE INVENTION

The present invention pertains to an apparatus and a method for providing anonymous shipping services and, in particular, to an apparatus and a method for providing anonymous shipping services in a network environment and/or in a non-network environment.

### BACKGROUND OF THE INVENTION

There is no doubt that many millions of commercial transactions occur each year. A substantial portion of these transactions occur and/or result from transactions which do not involve the parties coming face to face with each other. Instead, many of these transactions occur between individuals and entities which are located remotely from each other. Further, many of these transactions are non-cash transactions which can involve the use of credit accounts, charge accounts, and/or debit accounts, and/or which involve credit card accounts, charge card accounts, and/or debit card accounts. As a result, issues regarding the identities of the parties to transactions, as well as issues involving security, can often arise.

In the current environment, consumers must typically disclose identifying information (e.g., name, address, telephone number, e-mail address, etc.), in order to purchase and/or receive goods and/or to access services. Some providers allow consumers to purchase goods or access services with the assurance that identifying information will not be provided to the companies and/or individuals from which or from whom they purchase the goods from or access the services from.

While numerous entities and/or organizations are involved in transactions with consumers, there appears to be no system which allows a consumer to remain totally anonymous when purchasing and/or when receiving goods and/or when accessing services. Anonymity is typically lost whenever goods, products, and/or services, are shipped and/or otherwise provided to a consumer.

Current shipping services and/or solutions require the name, address, and telephone number, of the consumer or the receiver of the goods, products, and/or services. In this regard, consumer identifying information and/or identification information can readily become known to the provider or other third parties.

The drawbacks and disadvantages of the current transaction systems and transaction environments result in consumers buying and browsing habits being tracked and/or sold to third parties. The aforementioned tracking and selling of consumer buying and browsing information and/or habits, and/or the risk of same, is becoming even more prevalent on the Internet and/or the World Wide Web. In addition, the tracking and selling of consumer related information can also subject consumers to unwanted and/or unsolicited offers and/or advertisements, e-mail spam, and/or telemarketing and targeted marketing efforts, involving goods, products, and/or services, in both the Internet and the non-Internet environments.

Information regarding the buying and/or browsing habits of consumers can also be readily combined with other individual information, including individual identification information, individual salary information, and individual credit history information, in order to provide an individual profile. These individual profiles can disclose consumer browsing and/or purchasing habits and activities, and can result in the consumer becoming the target of unwelcome offerings and/or advertisements, as well as releasing private and/or other identification information regarding the consumer to third parties.

Even if a merchant takes great steps to preserve the consumer's anonymity, anonymity can nevertheless be lost, and/or identification information can be disseminated, when a shipment of goods, products, and/or services, takes place. It is at this time when the consumer's name, address, telephone number, and/or any other consumer identification information, associated with the purchase, can become known to goods, products, and/or service, providers and/or to other third parties.

### SUMMARY OF THE INVENTION

The present invention pertains to an apparatus and a method for providing anonymous shipping services and, in particular, to an apparatus and a method for providing anonymous shipping services in a network environment and/or in a non-network environment.

The apparatus and method of the present invention facilitates anonymous shipping services by concealing the identity of the purchaser or the recipient of goods, products and/or services. The apparatus and method of the present invention serves to provide anonymous shipping information to a provider of goods, products, and/or services, in order to conceal the identity of the purchaser or the recipient of the goods, products, and/or services. Thereafter, the respective good, product, and/or service, can be shipped and/or otherwise transported to the purchaser or recipient via a shipper or carrier who or which is capable of determining the identity of the purchaser or recipient.

The anonymous shipping information can be provided by a central processing computer to a provider. The provider can then arrange for the shipment of the respective goods, products, and/or services, with a shipper or other carrier. The shipper or carrier can determine the identity of the recipient and the recipient's address and, thereafter, effect the delivery.

The apparatus can include a central processing computer or server computer. The central processing computer can provide control over the apparatus and can provide services for the various computers associated with the various individuals, users, providers, shipping service providers and/or their agents, brokers, and/or representatives, and financial institutions, who or which utilize the present invention.

The central processing computer can be any suitable computer, network computer, or computer system, for providing service for the various computers associated with the various individuals, users, providers, shipping service providers and/or their agents, brokers, and/or representatives, and financial institutions, who or which utilize the present invention. Any number of central processing computers can be utilized in order to provide the servicing functions described herein.

The apparatus can also include any number of user computers. Each user computer can be a computer or other communication device which is suitable for allowing the user to interact with the central processing computer(s) and/or with any of the other computers and/or communication devices described herein. Each user computer can be associated with any of the individuals, users, providers, shipping service providers and/or their agents, brokers, and/or representatives, and financial institutions, who or which utilize the apparatus and method of the present invention and/or any broker(s), agent(s), and/or representative(s) of same.

The apparatus can also include one or more provider computers which can be associated with any provider of goods, products, and/or services, described herein as utilizing the present invention. Each provider computer may be a computer or other communication device suitable for allowing the provider to interact with the central processing computer(s) and/or with any of the other computers and/or communication devices described herein. Each provider computer can be associated with any of the provider(s) of any goods, products and/or services, who or which utilize the apparatus and method of the present invention.

The apparatus can also include one or more shipping service provider computers. Each shipper computer may be a computer or other communication device suitable for allowing the shipping service provider to interact with the central processing computer(s) and/or with any of the other computers and/or communication devices described herein. Each shipper computer can be associated with any shipper, shipping service provider(s) of any goods, products and/or services, and/or shipping agent, shipping broker, and/or any third party shipping entity, who or which utilize the apparatus and method of the present invention, and/or any broker(s), agent(s), and/or representative(s) of same.

The apparatus can also include one or more financial institution computers. Each financial institution computer may be a computer or other communication device suitable for allowing the financial institution to interact with the central processing computer(s) and/or with any of the other computers and/or communication devices described herein. Each financial institution computer can be associated with any financial institution who or which utilizes the apparatus and method of the present invention, and/or any broker(s), agent(s), and/or representative(s) of same.

The apparatus can also include one or more third party shipping service provider computers. Each third party shipper computer may be a computer or other communication device suitable for allowing the third party shipping service provider to interact with the central processing computer(s) and/or with any of the other computers and/or communication devices described herein. Each third party shipper computer can be associated with any third party shipper, third party shipping service provider(s) of any goods, products and/or services, and/or shipping agent, shipping broker, and/or any third party shipping entity, who or which utilize the apparatus and method of the present invention.

Any of the central processing computers, the user computers, the provider computers, the shipper computers, the financial institution computers, and/or the third party shipper computers, can receive information from any of the central processing computers, the user computers, the provider computers, the shipper computers, the financial institution computers, and/or third party shipper computers, described herein and/or can transmit information to any of the other central processing computers, the user computers, the provider computers, the shipper computers, the financial institution computers, and/or the third party shipper computers.

Any one or more of the central processing computers, the user computers, the provider computers, the shipper computers, the financial institution computers, and/or the third party shipper computers, can be wireless communication devices, and/or can be computers or other processing devices and/or communication devices which can operate in a wireless communication environment, in a wired or line-connected environment, and/or in an combination and/or hybrid environment(s).

The central processing computers, the user computers, the provider computers, the shipper computers, the financial institution computers, and/or third party shipper computers, can communicate with one another, and/or be linked to one another, over a communication network and/or a wireless communication network. The present invention can be utilized on, and/or over, any communication. The present invention can also be utilized on or over the Internet and/or the World Wide Web. The present invention can also utilize wireless Internet and/or World Wide Web services, equipment and/or devices. Any of the central processing computers, the user computers, the provider computers, the shipper computers, the financial institution computers, and/or the third party shipper computers, can have a respective web site, web sites, web page, and/or web pages, associated therewith.

Each of the central processing computers, the user computers, the provider computers, the shipper computers, the financial institution computers, and/or third party shipper computers, can include a central processing computer, a random access memory device(s) RAM), a read only memory device(s) (ROM), a user input device, a display device, a transmitters), for transmitting signals and/or data and/or information to any one or more of the other computers or communication devices described herein, a receiver, for receiving signals and/or data and/or information from any of the other computers or communication devices described herein, and a database for storing any of the data, information, programs, and/or algorithms, for facilitating the operation of the respective computer(s) in performing the processing routines described herein.

Each of the central processing computers, the user computers, the provider computers, the shipper computers, the financial institution computers, and/or third party shipper computers, can also include output device and any other hardware and/or software needed and/or desired for facilitating the operation of the respective computer(s) as described herein.

The computers or communication devices utilized in conjunction with the present invention can have a respective web site, web sites, web page, and/or web pages, associated therewith.

The apparatus and method of the present invention can be utilized in order to facilitate and/or provide for the anonymous shipment of goods, products, and/or services. The present invention can also be utilized by a user to make a purchase of goods, products, and/or services, and arrange for the anonymous shipment of the respective goods, products, and/or services so as to conceal the user's identity and shipment address from the provider.

The apparatus and method of the present invention can also process financial information and/or financial transaction information in conjunction with providing the anonymous shipping services described herein.

The apparatus and method of the present invention can also transmit a user's order to a provider or to a provider computer while concealing the user's identity and delivery address from the provider.

The apparatus and method of the present invention can also facilitate the use of encoded shipping information, an encoded label, encrypted shipping information, an encrypted shipping label, and/or shipping information and/or a shipping label which disguises the user's or the recipient's identity and user's or the recipient's shipping address, and/or information related thereto. The encoded, encrypted, and/or disguised information can thereafter be respectively decoded, decrypted and/or deciphered by a shipper in order to effectuate the shipment or delivery while ensuring that the user's identity and/or address is concealed from the provider, thereby ensuring user anonymity vis-à-vis the provider.

The apparatus and method of the present invention can also effectuate shipment returns to the provider while maintaining anonymity of the user's or recipient's identity and/or shipping address.

The apparatus and method of the present invention can also be utilized in a similar and/or analogous manner with a third party shipper and/or with a shipping warehouse facility or operation.

The apparatus and method of the present invention can also be utilized in order to provide anonymous shipping services subsequent to a user obtaining information from a provider or from a provider computer. In this regard, a user may obtain information from a provider or from a provider computer and thereafter make the decision to purchase a good, a product, and/or a service, while desiring to remain anonymous to the provider or to the provider computer.

The apparatus and method of the present invention can also provide order confirmation information to a respective party. The apparatus and method of the present invention can also provide order fulfillment information to a respective party.

The apparatus and method of the present invention can also be utilized by dispensing with the processing of any financial information or financial transaction information, such as in instances when goods, products, and/or services may be offered for free or in no-payment scenarios.

The apparatus and method of the present invention can maintain anonymity of the user's or recipient's identity and/or shipping address during a return shipment of goods, products, and/or services. The apparatus and method of the present invention can provide and/or process return shipment information.

The apparatus and method of the present invention can be utilized in conjunction with security measures and/or security techniques.

The apparatus and method of the present invention can also correlate identification and shipping address information with a particular transaction(s) and/or shipment or delivery.

The apparatus and method of the present invention can provide information regarding the goods, products, and/or services, which are to be the subject of a transaction.

The apparatus and method of the present invention can b e utilized in conjunction which transaction forms. The transaction forms can be standardized forms and/or can be forms which are provided by any of the respective parties who or which utilize the apparatus and method of the present invention.

Accordingly, it is an object of the present invention to provide an apparatus and a method for providing anonymous shipping services.

It is another object of the present invention to provide an apparatus and a method for providing anonymous shipping services in a network environment.

It is still another object of the present invention to provide an apparatus and a method for providing anonymous shipping services which conceals the identity of a purchaser or recipient of goods, products, and/or services.

It is yet another object of the present invention to provide an apparatus and a method for providing anonymous shipping services which utilizes computers and/or communication devices in a communication network.

It is another object of the present invention to provide an apparatus and a method for providing anonymous shipping services which utilizes wireless computers and/or communication devices in communication network.

It is still another object of the present invention to provide an apparatus and a method for providing anonymous shipping services which can operate in a wireless communication network, a wired or line-connected communication network, and/or in a hybrid communication network.

It is yet another object of the present invention to provide an apparatus and a method for providing anonymous shipping services which utilizes computers and/or communication devices which are associated with each of the respective parties who or which utilize the present invention.

It is yet another object of the present invention to provide an apparatus and a method for providing anonymous shipping services which utilizes computers and/or communication devices which can communicate with any other computers or communication devices in the communication network.

It is another object of the present invention to provide an apparatus and a method for providing anonymous shipping services which can be utilized on or over any suitable communication network.

It is still another object of the present invention to provide an apparatus and a method for providing anonymous shipping services which can be utilized on or over the Internet and/or the World Wide Web.

It is yet another object of the present invention to provide an apparatus and a method for providing anonymous shipping services wherein the computer or communication devices utilized in conjunction therewith can have a respective web site, web sites, web page, and/or web pages, associated therewith.

It is another object of the present invention to provide an apparatus and a method for providing anonymous shipping services which can facilitate and/or which can provide for the anonymous shipment of goods, products, and/or services.

It is yet another object of the present invention to provide an apparatus and a method for providing anonymous shipping services which can be utilized so as to conceal the user's or recipient's identity and/or shipment address from the provider.

It is another object of the present invention to provide an apparatus and a method for providing anonymous shipping services which can process financial information and/or financial transaction information in conjunction with providing anonymous shipping services.

It is still another object of the present invention to provide an apparatus and a method for providing anonymous shipping services which can transmit a user's order to a provider or a provider computer while concealing the user's identity and delivery address from the provider.

It is yet another object of the present invention to provide an apparatus and a method for providing anonymous shipping services which provide encoded shipping information, an encoded label, encrypted shipping information, an encrypted shipping label, and/or shipping information and/or a shipping label which disguises the user's or the recipient's identity and the user's or the recipient's shipping address, and/or information related thereto.

It is another object of the present invention to provide an apparatus and a method for providing anonymous shipping services which can respectively decode, decrypt and/or decipher, encoded, encrypted, and/or disguised shipping information.

It is still another object of the present invention to provide an apparatus and a method for providing anonymous shipping services which can facilitate and/or provide for the anonymous return shipment of any goods, products, and/or services, to a respective provider.

It is yet another object of the present invention to provide an apparatus and a method for providing anonymous shipping services which can maintaining anonymity of the user's or recipient's identity and/or shipping address during a return shipment of goods, products, and/or services.

It is another object of the present invention to provide an apparatus and a method for providing anonymous shipping services which can be utilized in conjunction with a third party shipper.

It is still another object of the present invention to provide an apparatus and a method for providing anonymous shipping services which can be utilized in conjunction with a warehouse facility or a warehouse operation.

It is yet another object of the present invention to provide an apparatus and a method for providing anonymous shipping services which can be utilized by a user subsequent to the user obtaining information from a provider or from a provider computer.

It is another object of the present invention to provide an apparatus and a method for providing anonymous shipping services which can dispense with the processing of any financial information or financial transaction information.

It is still another object of the present invention to provide an apparatus and a method for providing anonymous shipping services wherein a central processing computer can be utilized as a financial institution or as a financial institution computer.

It is yet another object of the present invention to provide an apparatus and a method for providing anonymous shipping services which incorporates security measures and/or security techniques during operation.

It is yet another object of the present invention to provide an apparatus and a method for providing anonymous shipping services which correlates identification and shipping address information with a particular transaction(s) and/or shipment or delivery.

It is another object of the present invention to provide an apparatus and a method for providing anonymous shipping services which can provide information regarding the goods, products, and/or services, which are to be the subject of a transaction.

It is still another object of the present invention to provide an apparatus and a method for providing anonymous shipping services which utilizes transaction forms.

It is yet another object of the present invention to provide an apparatus and a method for providing anonymous shipping services which utilizes standardized transaction forms.

It is another object of the present invention to provide an apparatus and a method for providing anonymous shipping services which can determine whether sufficient funds exist for processing a transaction.

It is still another object of the present invention to provide an apparatus and a method for providing anonymous shipping services which can determine whether insufficient funds exist for processing a transaction.

It is still another object of the present invention to provide an apparatus and a method for providing anonymous shipping services which can provide order confirmation information to a respective party.

It is yet another object of the present invention to provide an apparatus and a method for providing anonymous shipping services which can provide order fulfillment information to a respective party.

It is another object of the present invention to provide an apparatus and a method for providing anonymous shipping services which can provide return shipment information.

It is still another object of the present invention to provide an apparatus and a method for providing anonymous shipping services which can process return shipment information.

Other objects and advantages will be apparent to one skilled in the art upon a review of the Description of the Preferred Embodiment taken in conjunction with the Drawings which follow.

### BRIEF DESCRIPTION OF THE DRAWINGS

In the Drawings:

FIG. 1 illustrates the apparatus of the present invention, in block diagram form;

FIG. 2 illustrates the central processing computer of FIG. 1, in block diagram form;

FIG. 3 illustrates the user computer of FIG. 1, in block diagram form;

FIG. 4 illustrates the provider computer of FIG. 1, in block diagram form;

FIG. 5 illustrates the shipper computer of FIG. 1, in block diagram form;

FIG. 6 illustrates the financial institution computer of FIG. 1, in block diagram form;

FIG. 7 illustrates the third party shipper computer of FIG. 1, in block diagram form;

FIGS. 8A, 8B, and 8C illustrate a flow diagram of a preferred embodiment method for utilizing the apparatus of the present invention; and

FIGS. 9A, 9B, and 9C illustrate a flow diagram of another preferred embodiment method for utilizing the apparatus of the present invention.

### DESCRIPTION OF THE PREFERRED EMBODIMENTS

The present invention pertains to an apparatus and a method for providing anonymous shipping services and, in particular, to an apparatus and a method for providing anonymous shipping services in a network environment.

The apparatus and method of the present invention facilitates anonymous shipping services by concealing the identity of the purchaser or the recipient of goods, products and/or services. The apparatus and method of the present invention provides anonymous shipping information to a provider of goods, products, and/or services, in order to conceal the identity of the purchaser or the recipient of the goods, products, and/or services. Thereafter, the respective good, product, and/or service, can be shipped and/or otherwise transported to the purchaser or recipient via a shipper or carrier who or which is capable of determining the identity of the purchaser or recipient.

In a preferred embodiment, anonymous shipping information is provided by a central processing computer to a provider. The provider can then arrange for the shipment of the respective goods, products, and/or services, with a shipper or other carrier. The shipper or carrier can determine the identity of the recipient and the recipient's address and, thereafter, effect the delivery.

Applicant hereby incorporates by reference herein the subject matter and teachings of U.S. Provisional Patent Application Ser. No. 60/222,466 which teaches and discloses an apparatus and method for providing anonymous shipping services. Applicant also hereby incorporates by reference herein the subject matter and teachings of U.S. Provisional Patent Application Ser. No. 60/912,563 which teaches and discloses an apparatus and method for facilitating an anonymous shipment and/or for facilitating anonymous transactions and/or anonymous communications.

As defined herein, the terms “individual”, “user”, “purchaser”, recipient”, or the plural of same, refer to any individuals, users, purchasers, buyers, recipients, and/or any agent(s), broker(s), and/or representatives, of same, who or which utilize the present invention in order to obtain anonymous shipping services.

As defined herein, the terms “provider”, “merchant”, “vendor”, “seller”, “store”, “retailer”, “Internet site”, and/or the plural of same, refer to any provider(s), merchant(s), vendor(s), seller(s), store(s), retailer(s), Internet site(s), and/o any agent(s), broker(s), and/or representative(s), of same, who or which utilize the present invention in order to sell or provide goods, products, and/or services.

As defined herein, the terms “shipper”, “shipping service provider”, “carrier”, “truck driver”, “delivery service provider”, “transporter”, and/or the plural of same, refer to any shipper(s), shipping service provider(s), carrier(s), truck driver(s), delivery service provider(s), transporter(s), and/or any agent(s), broker(s), and/or representative(s), of same, who or which provide shipping, delivery, and/or transportation services described herein.

As defined herein, the terms “financial institution”, “bank”, “credit union”, “credit card company”, “charge card company”, debit card company”, and the plural of same, refer to any financial institution(s), bank(s), credit union(s), credit card company or companies, charge card company or companies, debit card company or companies, and/or the agent(s), broker(s), and/or representative(s) of same, who or which provide financial services for any of the parties described herein during the operation and/or use of the present invention.

As defined herein, the terms “third party shipper”, “third party shipping service provider”, “third party carrier”, “third party delivery service provider”, “third party transporter”, and/or the plural of same, refer to any third party shipper(s), third party shipping service provider(s), third party carrier(s), third party delivery service provider(s), third party transporter(s), and/or any agent(s), broker(s), and/or representative(s), of same, who or which provide shipping, delivery, and/or transportation services described herein for or on behalf of another shipper or shipping service provider as the terms are defined herein.

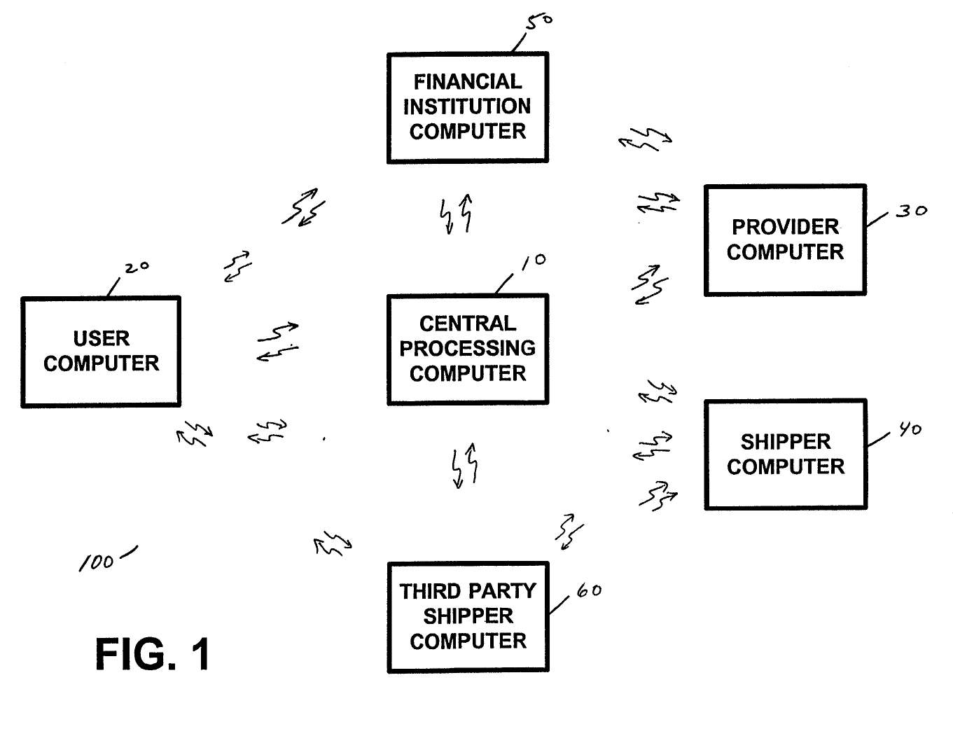

FIG. 1 illustrates a preferred embodiment of the apparatus of the present invention which is designated generally by the reference numeral 100. In FIG. 1, the apparatus 100 includes a central processing computer or server computer 10. The central processing computer 10 provides control over the apparatus 100 and provides services for the various computers associated with the various individuals, users, providers, shipping service providers and/or their agents, brokers, and/or representatives, and financial institutions, who or which utilize the present invention.

The central processing computer 10, in the preferred embodiment, can be any suitable computer, network computer, or computer system, for providing service for the various computers associated with the various individuals, users, providers, shipping service providers and/or their agents, brokers, and/or representatives, and financial institutions, who or which utilize the present invention.

In the preferred embodiment, any number of central processing computers 10 can be utilized in order to provide the servicing functions described herein. The central processing computer(s) 10 can be linked to other central processing computers or may be stand alone devices.

A given central processing computer 10 may service a particular geographic area or certain individuals, users, providers, shipping service providers and/or their agents, brokers, and/or representatives, and financial institutions who or which utilize the present invention. A central processing computer 10 may also be dedicated to service any one or group of the above described individuals and/or entities.

The apparatus 100, in the preferred embodiment, also includes any number of user computers 20. Each user computer 20 can be a personal computer or other communication device which is suitable for allowing the user to interact with the central processing computer(s) 10 and/or with any of the other computers and/or communication devices described herein. Each user computer 20 can be associated with any of the individuals, users, providers, shipping service providers and/or their agents, brokers, and/or representatives, and financial institutions, who or which utilize the apparatus and method of the present invention and/or any broker(s), agent(s), and/or representative(s) of same.

A user computer(s) 20 can also be a computer which is located at a public location, such as at a kiosk or other publicly accessible location, so that users may utilize the present invention from any suitable public location or environment.

Each user computer 20 can be utilized to transmit information to the central processing computer 10 and to receive information from the central processing computer 10 via the communication network.

The user computer 20 can be a personal computer, a hand-held computer, a palmtop computer, a laptop computer, a personal communication device, a personal digital assistant, a telephone, a wireless telephone, a digital telephone, a video telephone, a beeper, and/or a pager. The user computer 20 can also be a wireless communication device(s) and/or can be utilized in a wireless communications network or environment. The user computer 20 can also be a kiosk or other publicly situated computer and/or communication device. In the present invention, any number of user computers 20 can be utilized. In the present invention, each individual or user utilizing the present invention may have one or more user computers 20 associated therewith.

The apparatus 100, in the preferred embodiment, also includes one or more provider computers 30 which can be associated with any provider of goods, products, and/or services, described herein as utilizing the present invention. Each provider computer 30 may be a personal computer or other communication device suitable for allowing the provider to interact with the central processing computer(s) 10 and/or with any of the other computers and/or communication devices described herein. Each provider computer 30 can be associated with any of the provider(s) of any goods, products and/or services, who or which utilize the apparatus and method of the present invention.

The provider computer 30 can be a personal computer, a hand-held computer, a palmtop computer, a laptop computer, a personal communication device, a personal digital assistant, a telephone, a wireless telephone, a digital telephone, a video telephone, a beeper, and/or a pager. The provider computer 30 can also be a wireless communication device(s) and/or can be utilized in a wireless communications network or environment. In the present invention, any number of provider computers 30 can be utilized. In the present invention, each provider utilizing the present invention may have one or more provider computers 30 associated therewith.

Each provider computer 30 can be utilized to transmit information to the central processing computer 10 and receive information from the central processing computer 10 via the communication network. Each provider computer 30 can transmit information to and receive information from any of the user computers 20 and/or provider computers 30 described herein.

The apparatus 100, in the preferred embodiment, also includes one or more shipping service provider computers 40 (hereinafter referred to as “shipper computer 40” or “shipper computers 40”). Each shipper computer 40 may be a personal computer or other communication device suitable for allowing the shipping service provider to interact with the central processing computer(s) 10 and/or with any of the other computers and/or communication devices described herein. Each shipper computer 40 can be associated with any shipper, shipping service provider(s) of any goods, products and/or services, and/or shipping agent, shipping broker, and/or any third party shipping entity, who or which utilize the apparatus and method of the present invention, and/or any broker(s), agent(s), and/or representative(s) of same.

The shipper computer(s) 40 can be a personal computer, a hand-held computer, a palmtop computer, a laptop computer, a personal communication device, a personal digital assistant, a telephone, a wireless telephone, a digital telephone, a video telephone, a beeper, and/or a pager. The shipper computer 40 can also be a wireless communication device(s) and/or can be utilized in a wireless communications network or environment. In the present invention, any number of shipper computers 40 can be utilized. In the present invention, each shipper utilizing the present invention may have one or more shipper computers 40 associated therewith.

Each shipper computer 40 can be utilized to transmit information to the central processing computer 10 and receive information from the central processing computer 10 via the communication network. Each shipper computer 40 can transmit information to and receive information from any of the user computers 20, provider computers 30, and/or shipper computers 40 described herein.

The apparatus 100, in the preferred embodiment, also includes one or more financial institution computers 50. Each financial institution computer 50 may be a personal computer or other communication device suitable for allowing the financial institution to interact with the central processing computer(s) 10 and/or with any of the other computers and/or communication devices described herein. Each financial institution computer 50 can be associated with any financial institution who or which utilizes the apparatus and method of the present invention, and/or any broker(s), agent(s), and/or representative(s) of same.

The financial institution computer(s) 50 can be a personal computer, a hand-held computer, a palmtop computer, a laptop computer, a personal communication device, a personal digital assistant, a telephone, a wireless telephone, a digital telephone, a video telephone, a beeper, and/or a pager. The financial institution computer(s) 50 can also be a wireless communication device(s) and/or can be utilized in a wireless communications network or environment. In the present invention, any number of financial institution computers 50 can be utilized. In the present invention, each financial institution utilizing the present invention may have one or more financial institution computer(s) 50 associated therewith.

Each financial institution computer(s) 50 can be utilized to transmit information to the central processing computer 10 and receive information from the central processing computer 10 via the communication network. Each financial institution computer(s) 50 can transmit information to and receive information from any of the user computers 20, provider computers 30, shipper computers 40, and/or financial institution computers 50 described herein.

The apparatus 100, in the preferred embodiment, Can also include one or more third party shipping service provider computers 60 (hereinafter referred to as “third party shipper computer 60” or “third party shipper computers 60”). Each third party shipper computer 60 may be a personal computer or other communication device suitable for allowing the third party shipping service provider to interact with the central processing computer(s) 10 and/or with any of the other computers and/or communication devices described herein. Each third party shipper computer 40 can be associated with any third party shipper, third party shipping service provider(s) of any goods, products and/or services, and/or shipping agent, shipping broker, and/or any third party shipping entity, who or which utilize the apparatus and method of the present invention.

The third party shipper computer(s) 60 can be a personal computer, a hand-held computer, a palmtop computer, a laptop computer, a personal communication device, a personal digital assistant, a telephone, a wireless telephone, a digital telephone, a video telephone, a beeper, and/or a pager. The third party shipper computer 60 can also be a wireless communication device(s) and/or can be utilized in a wireless communications network or environment. In the present invention, any number of third party shipper computers 60 can be utilized. In the present invention, each third party shipper utilizing the present invention may have one or more third party shipper computers 60 associated therewith.

Each third party shipper computer 60 can be utilized to transmit information to the central processing computer 10 and receive information from the central processing computer 10 via the communication network. Each third party shipper computer 60 can transmit information to and receive information from any of the user computers 20, provider computers 30, shipper computers 40, financial institution computers 50, and/or third party shipper computers described herein.

Any of the central processing computers 10, the user computers 20, the provider computers 30, the shipper computers 40, the financial institution computers 50, third party shipper computers 60, can receive information from any of the central processing computers 10, the user computers 20, the provider computers 30, the shipper computers 40, and the financial institution computers 50, and/or third party shipper computers 60 herein and/or can transmit information to any of the other central processing computers 10, the user computers 20, the provider computers 30, the shipper computers 40, the financial institution computers 50, third party shipper computers 60.

Each of the central processing computers 10, the user computers 20, the provider computers 30, the shipper computers 40, the financial institution computers 50, third party shipper computers 60, can be wireless communication devices, and/or can be computers or other processing devices and/or communication devices which can operate in a wireless communication environment, in a wired or line-connected environment, and/or in an combination and/or hybrid environment(s).

The central processing computers 10, the user computers 20, the provider computers 30, the shipper computers 40, the financial institution computers 50, third party shipper computers 60, can communicate with one another, and/or be linked to one another, over a communication network and/or a wireless communication network. In the preferred embodiment, the present invention is utilized on, and/or over, the Internet and/or the World Wide Web.

The present invention, in the preferred embodiment, can also utilize wireless Internet and/or World Wide Web services, equipment and/or devices. The central processing computer(s) 10, in the preferred embodiment, has a respective web site, web sites, web page, and/or web pages, associated therewith. Any of the central processing computers 10, the user computers 20, the provider computers 30, the shipper computers 40, the financial institution computers 50, third party shipper computers 60, can also have a respective web site, web sites, web page, and/or web pages, associated therewith.

Although the Internet and/or the World Wide Web is described as being a preferred communication system and/or medium utilized, the present invention, in all of the embodiments described herein, can also be utilized with any appropriate communication system(s) including, but not limited to, network communication systems, telephone communication systems, cellular communication systems, digital communication systems, personal communication systems, personal communication services (PCS) systems, satellite communication systems, third generation (3G) communication systems, broad band communication systems, low earth orbiting (LEO) satellite systems, and/or public switched telephone networks or systems.

In the preferred embodiment, each of the central processing computers 10, the user computers 20, the provider computers 30, the shipper computers 40, the financial institution computers 50, third party shipper computers 60, can transmit data and/or information using TCP/IP, as well as any other Internet and/or World Wide Web, protocols.

In the preferred embodiment, and of central processing computers 10, the user computers 20, the provider computers 30, the shipper computers 40, the financial institution computers 50, third party shipper computers 60, can be linked directly or indirectly with any other central processing computers 10, the user computers 20, the provider computers 30, the shipper computers 40, the financial institution computers 50, third party shipper computers 60. In this manner, any of the central processing computers 10, the user computers 20, the provider computers 30, the shipper computers 40, the financial institution computers 50, third party shipper computers 60, can be linked, directly and/or indirectly, with any other central processing computers 10, the user computers 20, the provider computers 30, the shipper computers 40, the financial institution computers 50, third party shipper computers 60, so as to facilitate a direct or indirect bi-directional communication between any of the respective computers.

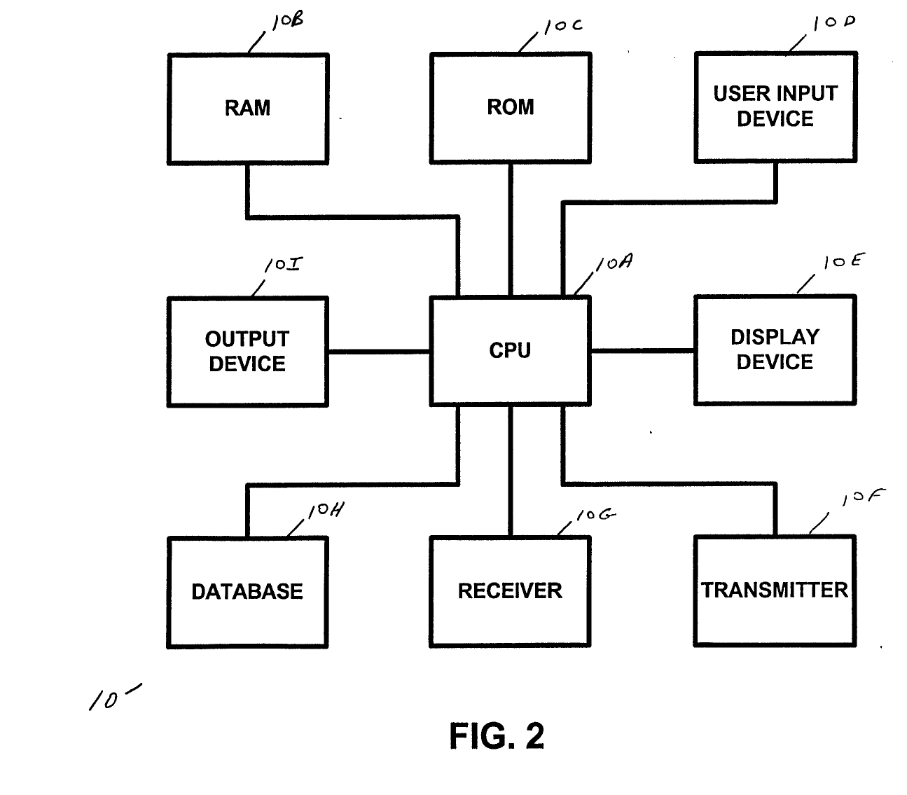

FIG. 2 illustrates the central processing computer 10, in block diagram form. The central processing computer 10, in the preferred embodiment, is a network computer or computer system which can be utilized as a central processing computer, an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory device(s) 10C (ROM), each of which is connected to the CPU 10A, a user input device 10D, for entering data and/or commands into the central processing computer 10, which includes any one or more of a keyboard, a scanner, a user pointing device, such as, for example, a mouse, a touch pad, a biometric devices(s), such as a voice recognition device, a retinal scanning device, a fingerprint recognition device, a palm scanning device, a barcode reader, a card reader, etc., if desired, which input device(s) are also connected to the CPU 10A. The central processing computer 10 also includes a display device 10E for displaying data and/or information to a user or operator.

The central processing computer 10 also includes a transmitter(s) 10F, for transmitting signals and/or data and/or information to any one or more of the user computers 20, the provider computers 30, the shipper computers 40, the financial institution computers 50, third party shipper computers 60, and/or to any other central processing computer(s) 10, which may be utilized in conjunction with the present invention. The central processing computer 10 also includes a receiver 10G, for receiving signals and/or data and/or information from any one or more of central processing computers 10, the user computers 20, the provider computers 30, the shipper computers 40, the financial institution computers 50, third party shipper computers 60, and/or to any other central processing computer(s) 10.

The central processing computer 10 also includes a database(s) 10H which contains data and/or information pertaining to any of the users, operators, providers, shipping service providers, and financial institutions, who or which utilize the apparatus and method of the present invention. The database 10H can include any data and/or information needed and/or desired for performing any of the functions and/or services described herein as being provided by the apparatus and method of the present invention.

The database 10H can contain, for example, name, address, phone number, facsimile number, e-mail address, and/or any other information regarding any of the individuals, users, providers, shippers, financial institutions, and/or third party shippers, described herein.

The database 10H can contain identification information which can include identification information for any of the individuals, users, providers, shippers, financial institutions, and/or third party shippers, described herein. The database 10H can also contain account number information, name information, address information, including address, street address, city, state, country, and/or zip code, for any of the individuals, users, providers, shippers, financial institutions, and/or third party shippers, described herein. The database 10H can also contain telephone number information, facsimile information, e-mail information, merchant site membership information, password and/or password information, uniform resource locator (URL) information, memory jogger information, and cookie information.

The database 10H can also contain financial information for any of the individuals, users, providers, shippers, financial institutions, and/or third party shippers, described herein. The database 10H can contain account number information, payment source and/or method information, credit information, credit card company information, charge card company information, debit card company information, credit card number and expiration information, charge card number and expiration information, debit card number and expiration, electronic funds transfer information, band and/or financial institution information, American Banking Association (ABA) routing number information, electronic funds account number information, money order information, money order number information, checking account information, check information, on-line checking information, internet cash information, internet currency information, gift certificate information, on-line or e-mail gift certificate information, and/or any other information regarding and/or related to any entity, entities, or money-type vehicles, which can represent value and which can be utilized in transactions involving commerce.

The database 10H can also contain password vault information for any of the individuals, users, providers, shippers, financial institutions, and/or third party shippers, described herein. The database 10H can also contain user account information and user account number information for any of the respective individuals, users, providers, shippers, financial institutions, and/or third party shippers, who or which utilize the present invention, Web site identification number information, user log-in information, passwords and/or password information, memory jogger information, vendor identification number information, and customer identification information.

The database 10H can also contain shipping information which can include, but which is not limited to, any and all of the information needed for providing any of the shipping services described herein.

The database 1H can also contain historical transaction information which can include, but which is not limited to, any information regarding past transactions.

The database 10H can also contain account information which can include, but which is not limited to, subscription information, subscriber information, and membership information.

The database 10H can also contain security information which can include, but which is not limited to, password information, information regarding passwords provided or assigned by the operator of the apparatus 100, barcode information, card reader information, magnetic strip information, electronic signature information, identification recognition information, fingerprint scanning/recognition information, retinal scanning/ recognition information, palm print scanning/recognition information, and voice recognition information.

The database 10H can also contain e-mail information which can include, but which is not limited to, user identification and/or user account number information, e-mail name information, user name information, received item information which can include, but which is not limited to, date(s) of receipt, subject of e-mail, size of e-mail, and deletion date information, and save item information which can include, but which is not limited to, date saved, subject of e-mail, size of e-mail, and deletion date information.

The database 10H can also contain complaint and/or customer service information which can include, but which is not limited to, data of complaint, complaint tracking number, user identification and/or user account number, merchant identification number, shipper identification number, nature of complaint, customer service or support individual, complaint forwarding information, resolution information, resolution date information, and any comments.

The database 10H can also contain URL, links, and/or linking information for or regarding any of the information described as being utilized herein.

The database 10H can also contain purchase confirmation information for or regarding any purchases or sales made via the apparatus and method of the present invention.

The database 10H can also contain a URL database which can include, but which is not limited to, URL identification number information. The database 10H can also contain client profile information, vendor validation information, vendor directory information, help and/or tutorial information, frequently asked questions (FAQs) information, and demonstration information. The database 10H can also contain escrow account database information.

The database 10H can also contain label information, shipping information, which can include, but which is not limited to, anonymous label information, anonymous shipping information, non-anonymous label information, and non-anonymous shipping information. The database 10H can also contain any information and/or data for providing encrypted, encoded, and/or disguised, labels and/or shipping information which serve to facilitate the anonymous shipping services described herein.

The database 10H can also contain credit card information, charge card information, debit card information. The database 10H can also contain centralized account information for credit card accounts, charge card accounts, debit card accounts, financial account information, electronic funds transfer (EFT) information, account processing information, and/or centralized clearinghouse information. The database 10H can also include account information for accounts, financial and/or otherwise, which may be administered, maintained, and/or managed, by private service providers who or which may operate and/or utilize the apparatus and method of the present invention.

The database 10H can also contain vendor profile information. The database 10H can also contain contact information for or regarding any of the individuals, users, providers, shippers, financial institutions, and/or third party shippers, described herein.

The database 10H can also contain encryption and/or encoding information which can include, but which is not limited to, electronic signature information, barcode information, magnetic code information, and bio-metric code information.

The database 10H can also include advertising information which can include, but which is not limited to, list advertisement information, banner advertisement information, links and/or hyperlinks to other sites, web sites, web pages, and/or content, referral incentive information, referral tracking information, tracking link information, mailing list information, search engine information, and directory information for or regarding any other sites, web sites, and/or vendors.

The database 10H can also contain franchise information, franchiser information and/or franchisee information.

The database 10H can also contain information for protecting social security numbers and information for protecting the identity of any of the individuals, users, providers, shippers, financial institutions, and/or third party shippers, described herein.

The database 10H can also include information for facilitating the making of anonymous donations, anonymous tips, anonymous information to law enforcement, public and/or private organizations and/or entities, anonymous rewards, anonymous internet service provider service, anonymous chat rooms, etc. The database 10H can also contain information for facilitating the making of anonymous confessions, the anonymous return of goods and/or funds, such as goods and/or funds obtained via theft, fraud, insurance fraud, etc. The database 10H can also contain information for facilitating the making of anonymous bids for contracts and/or anonymous bids in auctions.

The database 10H can also contain information for facilitating the making of or submission of anonymous job applications, the payment of bills, and the giving of anonymous gifts and/or gift certificates.

The database 10H can also contain information for setting credit limits, charge limits, and debit limits as well as setting parameter regarding use of the respective accounts. The database 10H can also include information for processing any and all of the transactions which can be processed by or via the apparatus and method of the present invention. The transaction processing information can include, but which is not limited to, information for processing financial transactions, customer information, updated customer information, vendor information, updated vendor information, shipping information, updated shipping information, history file information, updated history file information, and information for processing account information of any type.

The database 10H can also contain information regarding standard forms, standard transaction forms and documents, for any of the transactions which can take place via the apparatus and method of the present invention as well as any transactions which can be processed by the apparatus 100. The database 10H can contain standardized forms and/or standardized form information for or regarding any transactions which can take place between the central processing computer 10 and any of the users, user computers 20, the providers, the provider computers 30, the shippers, the shipper computers 40, the financial institutions, the financial institution computers 50, the third party shippers, and/or the third party shipper computers 60. The database 10H can also contain information for automatically providing certain information into the forms and/or into certain fields of the forms for any of the respective parties described herein.

In addition to containing standardized forms and/or standardized form information, the database 10H can also contain forms provided by any of the respective users, providers, shippers, financial institutions, and/or third party shippers. The database 10H can also contain information for correlating the respective forms with the respective users, providers, shippers, financial institutions, and/or third party shippers, as well as information for automatically providing certain information into the forms and/or into certain fields of the forms.

The standard or standardized forms, and/or the forms provided by any of the respective users, providers, shippers, financial institutions, and/or third party shippers, can also be utilized for any of the transactions described herein and can also include information, such as anonymous information and/or other information, which can be filled in automatically by the central processing computer 10, once received by a respective user, provider, shipper, financial institution, and/or third party shipper, such as information which may be obtained at the time a respective user, provider, shipper, financial institution, and/or third party shipper, registers with the apparatus 100.

Any of the forms which are stored in the database 10H can also be provided by the operator or administrator of the apparatus 100 of the present invention and/or by any of the providers, shippers, financial institutions, and/or third party shippers, described herein, who or which utilize the apparatus 100.

In the above-described manner, any user, provider, shipper, financial institution, and/or third party shipper, can dictate the type or kind of form(s) with which they desire to conduct transactions. The database 10H of the central processing computer 10 can contain information and/or software programs for facilitating the providing of any of the information needed to complete any of the herein-described forms.

The database 10H can store any form information for any of the users and/or other providers, shippers, financial institutions, and/or third party shippers, who or which utilize the present invention. The stored information can thereafter be utilized as needed to process transactions regarding any of the respective users or parties.

The database 10H can also contain information regarding buyers of goods, products, and/or services via the present invention. The database 10H can also contain information regarding sellers of goods, products, and/or services via the present invention.

The database 10H can also contain information regarding active accounts as well as archived information regarding these accounts. The database 10H can also contain information for processing referrals. The database 10H can also contain marketing information, information regarding vendors, server application name(s), shopping cart information, and financial information.

The database 10H can also contain user identification information which can include, but which is not limited to, individual, user, or merchant information, account number information, name information, address information, e-mail address information, merchant site membership information, password(s) and/or password information, URL information, memory jogger information, and cookie information.

The database 10H can also contain tracking information which can include shipping tracking information, shipment tracking identification number information, transaction identification information, transaction city, state, country and zip code, shipping company and/or carrier information, shipper and/or merchant information which can include, but which is not limited to, identification number, name of shipping party, and address information of shipping party or shipping parties, including address, city, state, country and zip code, identification number information, delivery information which can include, but which is not limited to, account number information, name of receiving party or receiving parties, address information of receiving party, including address, city, state, country and zip code.

The database 10H can also contain transaction information which can include, but which is not limited to, transaction identification number, merchant identification number information, transaction dates, activity dates, goods, products, items, and/or services, purchased, information regarding purchase amounts, information regarding shipping costs, and information regarding sales taxes.

The database 10H can also contain security and/or password information which can include, but which is not limited to user account number information, web site information, user log-on and/or log-in information, password(s) and/or password information, memory jogger information, vendor identification information, and customer identification information.

The database 10H can also contain returned goods information which can include, but which is not limited to, transaction identification information, transaction identification number information, user identification number information, transaction date information, activity date information, merchant identification information, merchant identification number information, refund information, credit information, shipped back information, shipped back date information, and shipper information and/or carrier information.

The database 10H can also contain shipping rate information which can include rate information for shipping from a certain zip code(s) to a certain zip code(s), carrier rate information, next-day delivery information, 2^{nd} day delivery information, 3^{rd} day delivery information, ground delivery information, air delivery information and/or sea delivery information.

The database 10H can also contain information regarding any and all applicable country, state, county, and/or local, taxes, duties, tariffs, import fees, export fees, customs charges, and/or any other applicable taxes, fees and/or charges.

The database 10H can also contain any data, information, software programs, software algorithms, and/or software information which can be utilized and/or which can be needed and/or desired for performing any of the processing routines and/or functions described herein. The database 10H can also contain any suitable software for allowing any of the users, providers, shippers, financial institutions, and/or third party shippers, to access the central processing computer 10 and/or perform transactions with the central processing computer 10.

The database 10H can also contain any suitable software for allowing any of the users, providers, shippers, financial institutions, and/or third party shippers, to access the central processing computer 10 and/or perform transactions with the central processing computer 10 via their respective user computer(s) 20, provider computer(s) 30, shipper computer(s) 40, financial institution computer(s) 50, and/or third party shipper computer(s) 60, and/or from any other computer or communication device having access to the communication network on or over which the apparatus 100 can operate.

With reference once again to FIG. 2, the central processing computer 10 also includes an output device 10I such as a printer, a modem, a fax/modem, or other output device, for providing data and/or information to the operator or user of the central processing computer 10 or to a third party or third party entity.

The central processing computer 10 can also include any other hardware and/or software for facilitating the operation of the central processing computer 10 as described herein.

In the preferred embodiment, each of the central processing computers 10, the user computers 20, the provider computers 30, the shipper computers 40, the financial institution computers 50, third party shipper computers 60, can include the same, similar, or analogous, components and/or peripheral devices as described herein for the central processing computer 10. In this manner, any of the user computers 20, the provider computers 30, the shipper computers 40, the financial institution computers 50, third party shipper computers 60, may be the same as, or be similar to, the central processing computer 10. In this regard, and depending upon the application, each of the central processing computers 10, the user computers 20, the provider computers 30, the shipper computers 40, the financial institution computers 50, third party shipper computers 60, can have the same or similar components as the central processing computer 10.

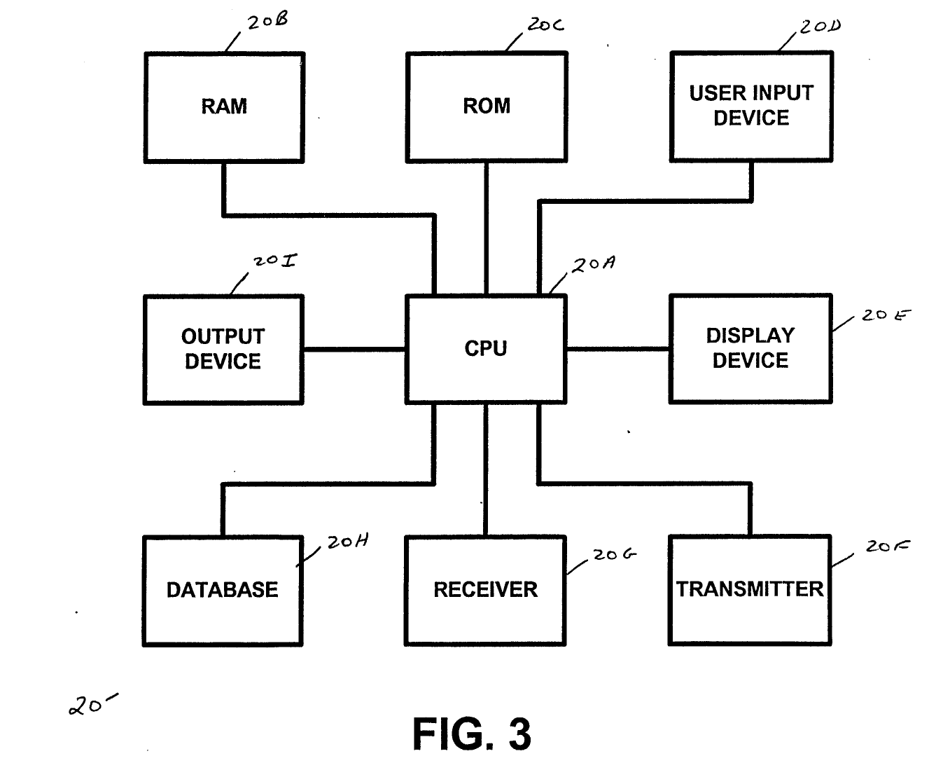

FIG. 3 illustrates the user computer 20, in block diagram form. The user computer 20, in the preferred embodiment, can be a computer, personal computer, or communication device, described herein, and/or any other suitable or appropriate computer and/or communication device which can be utilized as a user computer. In the preferred embodiment, the user computer 20 includes a central processing unit or CPU 20A, which in the preferred embodiment, is a microprocessor. The CPU 20A may also be a microcomputer, a minicomputer, a macro-computer, and/or a mainframe computer, depending upon the application.

The user computer 20 also includes a random access memory device(s) 20B (RAM) and a read only memory device(s) 20C (ROM), each of which is connected to the CPU 20A, a user input device 20D, for entering data and/or commands into the user computer 20, which includes any one or more of a keyboard, a scanner, a user pointing device, such as, for example, a mouse, a touch pad, a biometric devices(s), such as a voice recognition device, a retinal scanning device, a fingerprint recognition device, a barcode reader, a card reader, etc., if desired, which input device(s) are also connected to the CPU 20A. The user computer 20 also includes a display device 20E for displaying data and/or information to a user or operator.

The user computer 20 also includes a transmitter(s) 20F, for transmitting signals and/or data and/or information to any one or more of the central processing computers 10, the provider computers 30, the shipper computers 40, the financial institution computers 50, third party shipper computers 60, and/or to any other user computer(s) 10, which may be utilized in conjunction with the present invention. The user computer 20 also includes a receiver 20G, for receiving signals and/or data and/or information from any one or more of central processing computers 10, the provider computers 30, the shipper computers 40, the financial institution computers 50, third party shipper computers 60, and/or to any other user computer(s) 20.

The user computer 20 also includes a database(s) 20H which contains data and/or information pertaining to any of the users, operators, providers, shipping service providers, and financial institutions, who or which utilize the apparatus and method of the present invention. The database 20H can include any data and/or information needed and/or desired for performing any of the functions and/or services described herein as being provided by the apparatus and method of the present invention.

The database 20H can contain, for example, name, address, phone number, facsimile number, e-mail address, and/or any other information regarding any of the individuals, users, providers, shippers, financial institutions, and/or third party shippers, described herein.

The database 20H can contain identification information which can include identification information for any of the individuals, users, providers, shippers, financial institutions, and/or third party shippers, described herein. The database 20H can also contain account number information, name information, address information, including address, street address, city, state, country, and/or zip code, for any of the individuals, users, providers, shippers, financial institutions, and/or third party shippers, described herein. The database 20H can also contain telephone number information, facsimile information, e-mail information, merchant site membership information, password and/or password information, uniform resource locator (URL) information, memory jogger information, and cookie information.

The database 20H can also contain financial information for any of the individuals, users, providers, shippers, financial institutions, and/or third party shippers, described herein. The database 20H can contain account number information, payment source and/or method information, credit information, credit card company information, charge card information, debit card information, credit card number and expiration information, charge card number and expiration information, debit card number and expiration, electronic funds transfer information, band and/or financial institution information, ABA routing number information, electronic funds account number information, money order information, money order number information, checking account information, check information, on-line checking information, internet cash information, internet currency information, gift certificate information, on-line or e-mail gift certificate information, and/or any other information regarding and/or related to any entity, entities, or money-type vehicle(s), which can represent value and which can be utilized in transactions involving commerce.

The database 20H can also contain password vault information for any of the individuals, users, providers, shippers, financial institutions, and/or third party shippers, described herein. The database 20H can also contain user account information and user account number information for any of the respective individuals, users, providers, shippers, financial institutions, and/or third party shippers, who or which utilize the present invention, Web site identification number information, user log-in information, passwords and/or password information, memory jogger information, vendor identification number information, and customer identification information.

The database 20H can also contain shipping information which can include, but which is not limited to, any and all of the information needed for providing any of the shipping services described herein. The database 20H can also contain historical transaction information which can include, but which is not limited to, any information regarding past transactions. The database 20H can also contain account information which can include, but which is not limited to, subscription information, subscriber information, and membership information.

The database 20H can also include security information which can include, but which is not limited to, password information, electronic signature information, information regarding passwords provided or assigned by the operator of the apparatus 100, barcode information, card reader information, magnetic strip information, fingerprint scanning information, retinal scanning information, palm scanning information, and voice recognition information.

The database 20H can also contain software information which can include, but which is not limited to, software programs and/or software algorithms which are utilized in performing any of the processing routines and/or functionality described herein.

The database 20H can also contain e-mail information which can include, but which is not limited to, user identification and/or user account number information, e-mail name information, user name information, received item information which can include, but which is not limited to, date(s) of receipt, subject of e-mail, size of e-mail, and deletion date information, and save item information which can include, but which is not limited to, date saved, subject of e-mail, size of e-mail, and deletion date information.

The database 20H can also contain complaint and/or customer service information which can include, but which is not limited to, date of complaint, complaint-related data and/or information, complaint tracking number, user identification and/or user account number, merchant identification number, shipper identification number, nature of complaint, customer service or support individual, complaint forwarding information, resolution information, resolution date information, and any comments. The database 20H can also contain URL, links, and/or linking information for or regarding any of the information described as being utilized herein.

The database 20H can also contain purchase confirmation information for or regarding any purchases or sales made via the apparatus and method of the present invention.

The database 20H can also contain any data, information, software programs, and/or software algorithms, which can be needed and/or desired for performing the processing routines and/or functions described herein. The database 20H can also contain any suitable software for allowing the user computer 20 to access, and/or perform transactions with, the central processing computer(s) 10 and/or any of the other user computers 20, provider computers 30, shipper computers 40, financial institution computers 50, and/or third party shipper computers 60, described herein. The database 20H can also contain any suitable software for allowing any of the central processing computer(s) operators, users, providers, shippers, financial institutions, and/or third party shippers, to access the user computers 20 and/or perform transactions with the user computers 20 via the respective central processing computer(s) 10, user computer(s) 20, provider computer(s) 30, shipper computer(s) 40, financial institution computer(s) 50, and/or third party shipper computer(s) 60, and/or from any other computer or communication device having access to the communication network on or over which the apparatus 100 can operate.

With reference once again to FIG. 3, the user computer 20 also includes an output device 20I such as a printer, a modem, a fax/modem, or other output device, for providing data and/or information to the operator or user of the user computer 20 or to a third party or third party entity.

The user computer 20 can also include any other hardware and/or software for facilitating the operation of the user computer 20 as described herein.

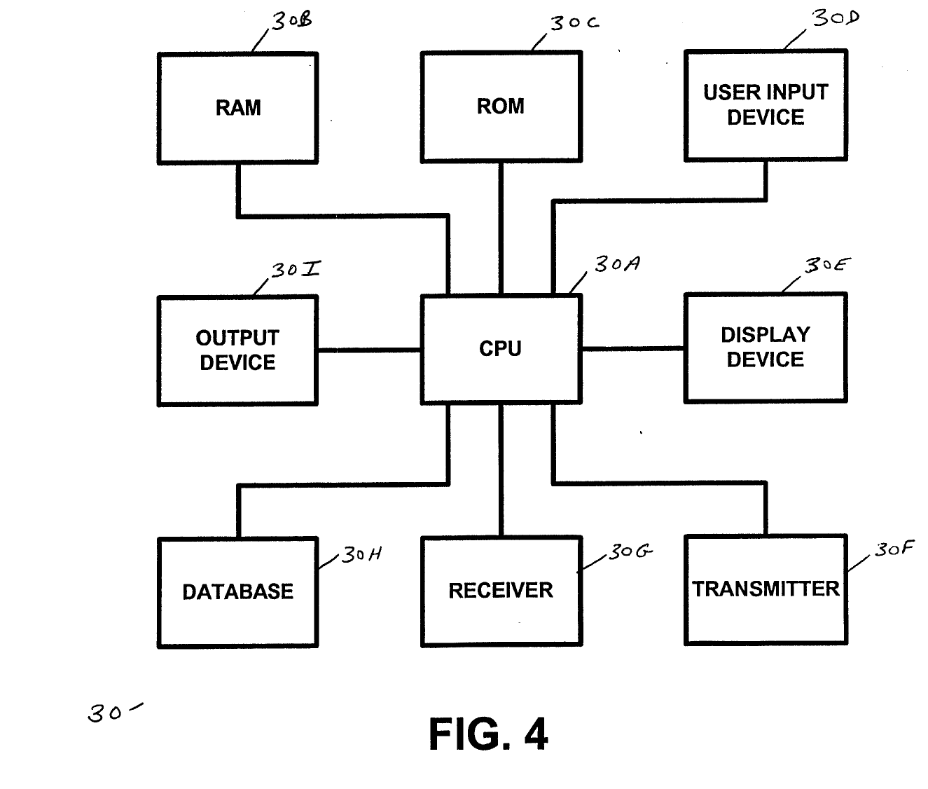

FIG. 4 illustrates the provider computer 30, in block diagram form. The provider computer 30, in the preferred embodiment, can be a computer, personal computer, or communication device, described herein, and/or any other suitable or appropriate computer and/or communication device which can be utilized as a provider computer. In the preferred embodiment, the provider computer 30 includes a central processing unit or CPU 30A, which in the preferred embodiment, is a microprocessor. The CPU 30A may also be a microcomputer, a minicomputer, a macro-computer, and/or a mainframe computer, depending upon the application.

The provider computer 30 also includes a random access memory device(s) 30B (RAM) and a read only memory device(s) 30C (ROM), each of which is connected to the CPU 30A, a user input device 30D, for entering data and/or commands into the provider computer 30, which includes any one or more of a keyboard, a scanner, a user pointing device, such as, for example, a mouse, a touch pad, a biometric devices(s), such as a voice recognition device, a retinal scanning device, a fingerprint recognition device, a barcode reader, a card reader, etc., if desired, which input device(s) are also connected to the CPU 30A. The provider computer 30 also includes a display device 30E for displaying data and/or information to a user or operator.

The provider computer 30 also includes a transmitter(s) 30F, for transmitting signals and/or data and/or information to any one or more of the central processing computers 10, the user computers 20, the shipper computers 40, the financial institution computers 50, third party shipper computers 60, and/or to any other provider computer(s) 30, which may be utilized in conjunction with the present invention. The provider computer 30 also includes a receiver 30G, for receiving signals and/or data and/or information from any one or more of central processing computers 10, the user computers 20, the shipper computers 40, the financial institution computers 50, third party shipper computers 60, and/or to any other provider computer(s) 30.

The provider computer 30 also includes a database(s) 30H which contains data and/or information pertaining to any of the users, operators, providers, shipping service providers, and financial institutions, who or which utilize the apparatus and method of the present invention. The database 30H can include any data and/or information needed and/or desired for performing any of the functions and/or services described herein as being provided by the apparatus and method of the present invention.

The database 30H can contain, for example, name, address, phone number, facsimile number, e-mail address, and/or any other information regarding any of the individuals, users, providers, shippers, financial institutions, and/or third party shippers, described herein.

The database 30H can also contain information regarding the goods, products, and/or services, offered by the provider, along with the names, descriptions and/or prices, and any other related information. The database 30H can also contain information regarding any of the individuals or users who utilize the apparatus and method of the present invention, as well as any of the shippers, financial institutions, and/or third party shipping entities, described herein.

The database 30H can also contain any of the information described herein as being stored in the respective databases of the central processing computers 10, the user computers 20, the shipper computers 30, the financial institution computers 50, the third party shipper computers 60, and/or any of the other provider computers 30.

The database 30H can also contain any data, information, software programs, and/or software algorithms, which can be needed and/or desired for performing the processing routines and/or functions described herein. The database 30H can also contain any suitable software for allowing the provider computer 30 to access, and/or perform transactions with, the central processing computer(s) 10 and/or any of the other user computers 20, provider computers 30, shipper computers 40, financial institution computers 50, and/or third party shipper computers 60, described herein.

The database 30H can also contain any suitable software for allowing any of the central processing computer(s) operators, users, providers, shippers, financial institutions, and/or third party shippers, to access the provider computers 30 and/or perform transactions with the provider computers 30 via the respective central processing computer(s) 10, user computer(s) 20, provider computer(s) 30, shipper computer(s) 40, financial institution computer(s) 50, and/or third party shipper computer(s) 60, and/or from any other computer or communication device having access to the communication network on or over which the apparatus 100 can operate.

With reference once again to FIG. 4, the provider computer 30 also includes an output device 30I such as a printer, a modem, a fax/modem, or other output device, for providing data and/or information to the operator or user of the provider computer 30 or to a third party or third party entity. The provider computer 30 can also include any other hardware and/or software for facilitating the operation of the provider computer 30 as described herein.

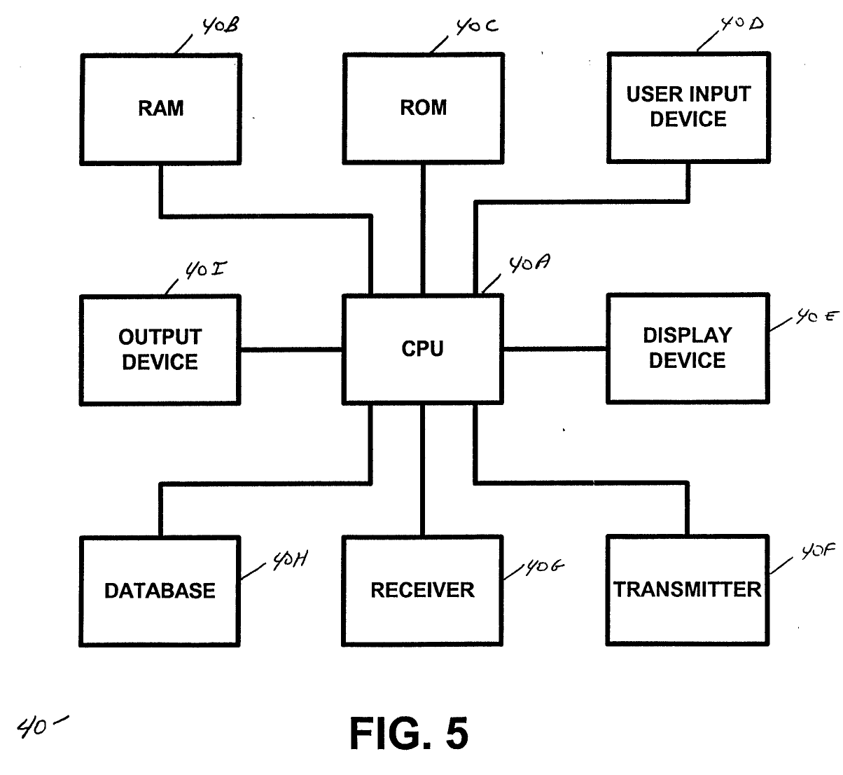

FIG. 5 illustrates the shipper computer 40, in block diagram form. The shipper computer 40, in the preferred embodiment, can be a computer, personal computer, or communication device, described herein, and/or any other suitable or appropriate computer and/or communication device which can be utilized as a shipper computer. In the preferred embodiment, the shipper computer 40 includes a central processing unit or CPU 40A, which in the preferred embodiment, is a microprocessor. The CPU 40A may also be a microcomputer, a minicomputer, a macro-computer, and/or a mainframe computer, depending upon the application.

The shipper computer 40 also includes a random access memory device(s) 40B (RAM) and a read only memory device(s) 40C (ROM), each of which is connected to the CPU 40A, a user input device 40D, for entering data and/or commands into the shipper computer 40, which includes any one or more of a keyboard, a scanner, a user pointing device, such as, for example, a mouse, a touch pad, a bio-metric devices(s), such as a voice recognition device, a retinal scanning device, a fingerprint recognition device, a barcode reader, a card reader, etc., if desired, which input device(s) are also connected to the CPU 40A. The shipper computer 40 also includes a display device 40E for displaying data and/or information to a user or operator.

The shipper computer 40 also includes a transmitter(s) 40F, for transmitting signals and/or data and/or information to any one or more of the central processing computers 10, the user computers 20, the provider computers 30, the financial institution computers 50, third party shipper computers 60, and/or to any other shipper computer(s) 30, which may be utilized in conjunction with the present invention. The shipper computer 40 also includes a receiver 40G, for receiving signals and/or data and/or information from any one or more of central processing computers 10, the user computers 20, the provider computers 30, the financial institution computers 50, third party shipper computers 60, and/or to any other shipper computer(s) 40.

The shipper computer 40 also includes a database(s) 40H which contains data and/or information pertaining to any of the users, operators, providers, shipping service providers, and financial institutions, who or which utilize the apparatus and method of the present invention. The database 40H can include any data and/or information needed and/or desired for performing any of the functions and/or services described herein as being provided by the apparatus and method of the present invention.

The database 40H can contain, for example, name, address, phone number, facsimile number, e-mail address, and/or any other information regarding any of the individuals, users, providers, shippers, financial institutions, and/or third party shippers, described herein.

The database 40H can also contain user identification information which can include, but which is not limited to, individual, user, or merchant information, account number information, name information, address information, e-mail address information, merchant site membership information, password(s) and/or password information, URL information, memory jogger information, and cookie information.

The database 40H can also contain tracking information which can include shipping tracking information, shipment tracking identification number information, transaction identification information, transaction city, state, country and zip code, shipping company and/or carrier information, shipper and/or merchant information which can include, but which is not limited to, identification number, name of shipping party, and address information of shipping party or shipping parties, including address, city, state, country and zip code, identification number information, delivery information which can include, but which is not limited to, account number information, name of receiving party or receiving parties, address information of receiving party, including address, city, state, country and zip code.

The database 40H can also contain transaction information which can include, but which is not limited to, transaction identification number, merchant identification number information, transaction dates, activity dates, goods, products, items, and/or services, purchased, information regarding purchase amounts, information regarding shipping costs, and information regarding sales taxes, duties, tariffs, import fees, export fees, customs charges, and/or any other applicable taxes, fees and/or charges.

The database 40H can also contain security information which can include, but which is not limited to, password(s) and/or password information, barcode information, card reader information, magnetic strip information, fingerprint scanner/reader information, retinal scanning information, palm print scanner/reader information, and voice recognition information.

The database 40H can also contain security and/or password information which can include, but which is not limited to user account number information, web site information, user log-on and/or log-in information, password(s) and/or password information, memory jogger information, vendor identification information, and customer identification information.

The database 40H can also contain any information and/or data for decoding, decrypting, and/or deciphering, any label(s) and/or shipping information in order to provide for the anonymous shipping services described herein.

The database 40H can also contain returned goods information which can include, but which is not limited to, transaction identification information, transaction identification number information, user identification number information, transaction date information, activity date information, merchant identification information, merchant identification number information, refund information, credit information, shipped back information, shipped back date information, and shipper information and/or carrier information.

The database 40H can also contain shipping rate information which can include rate information for shipping from a certain zip code(s) to a certain zip code(s), carrier rate information, next-day delivery information, 2^{nd} day delivery information, 3^{rd} day delivery information, ground delivery information, air delivery information and/or sea delivery information.

The database 40H can also contain information regarding any and all applicable country, state, county, and/or local, taxes, duties, tariffs, import fees, export fees, customs charges, and/or any other applicable taxes, fees and/or charges.

The database 40H can also contain any of the information described herein as being stored in the respective databases of the central processing computers 10, the user computers 20, the provider computers 30, the financial institution computers 50, the third party shipper computers 60, and/or any of the other shipper computers 30.

The database 40H can also contain any data, information, software programs, and/or software algorithms, which can be needed and/or desired for performing the processing routines and/or functions described herein. The database 40H can also contain any suitable software for allowing the shipper computer 40 to access, and/or perform transactions with, the central processing computer(s) 10 and/or any of the other user computers 20, provider computers 30, shipper computers 40, financial institution computers 50, and/or third party shipper computers 60, described herein.

The database 40H can also contain any suitable software for allowing any of the central processing computer(s) operators, users, providers, shippers, financial institutions, and/or third party shippers, to access the shipper computers 40 and/or perform transactions with the shipper computers 40 via the respective central processing computer(s) 10, user computer(s) 20, provider computer(s) 30, shipper computer(s) 40, financial institution computer(s) 50, and/or third party shipper computer(s) 60, and/or from any other computer or communication device having access to the communication network on or over which the apparatus 100 can operate.

With reference once again to FIG. 5, the shipper computer 40 also includes an output device 40I such as a printer, a modem, a fax/modem, or other output device, for providing data and/or information to the operator or user of the shipper computer 40 or to a third party or third party entity.

The shipper computer 40 can also include any other hardware and/or software for facilitating the operation of the shipper computer 40 as described herein.

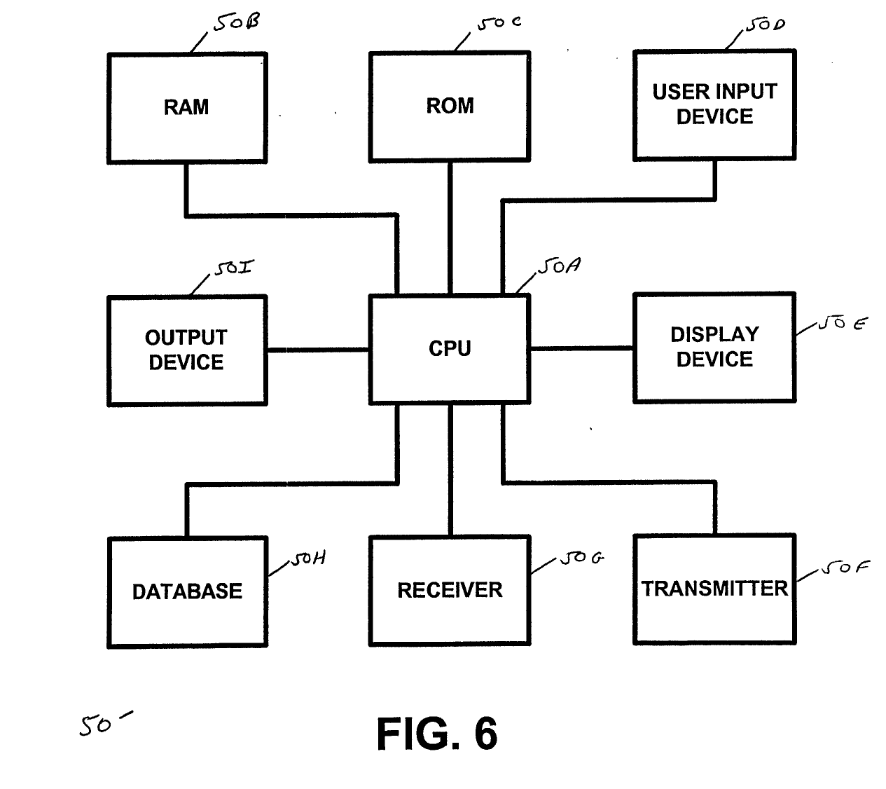

FIG. 6 illustrates the financial institution computer 50, in block diagram form. The financial institution computer 50, in the preferred embodiment, can be a computer, personal computer, or communication device, described herein, and/or any other suitable or appropriate computer and/or communication device which can be utilized as a shipper computer. In the preferred embodiment, the financial institution computer 50 includes a central processing unit or CPU 50A, which in the preferred embodiment, is a microprocessor. The CPU 50A may also be a microcomputer, a minicomputer, a macro-computer, and/or a mainframe computer, depending upon the application.

The financial institution computer 50 also includes a random access memory device(s) 50s (RAM) and a read only memory device(s) 50C (ROM), each of which is connected to the CPU 50A, a user input device SOD, for entering data and/or commands into the financial institution computer 50, which includes any one or more of a keyboard, a scanner, a user pointing device, such as, for example, a mouse, a touch pad, a biometric devices(s), such as a voice recognition device, a retinal scanning device, a fingerprint recognition device, a palm print reading device, an electronic signature input device, a barcode reader, a card reader, etc., if desired, which input device(s) are also connected to the CPU 50A. The financial institution computer 50 also includes a display device 50E for displaying data and/or information to a user or operator.

The financial institution computer 50 also includes a transmitter(s) SOF, for transmitting signals and/or data and/or information to any one or more of the central processing computers 10, the user computers 20, the provider computers 30, the shipper computers 40, third party shipper computers 60, and/or to any other financial institution computer(s) 50, which may be utilized in conjunction with the present invention. The financial institution computer 50 also includes a receiver 50G, for receiving signals and/or data and/or information from any one or more of central processing computers 10, the user computers 20, the provider computers 30, the shipper computers 40, the third party shipper computers 60, and/or to any other financial institution computer(s) 50.

The financial institution computer 50 also includes a database(s) 50H which contains data and/or information pertaining to any of the users, operators, providers, shipping service providers, and financial institutions, who or which utilize the apparatus and method of the present invention. The database 50H can include any data and/or information needed and/or desired for performing any of the functions and/or services described herein as being provided by the apparatus and method of the present invention.

The database 50H can contain, for example, name, address, phone number, facsimile number, e-mail address, and/or any other information regarding any of the individuals, users, providers, shippers, financial institutions, and/or third party shippers, described herein.

The database 50H can also contain financial account information, account number information, electronic funds transfer information, credit card account information, charge card account information, debit card account information, and/or any other information, financial and/or otherwise, for performing the processing of financial transaction for or on behalf of any of the individuals, users, providers, shippers, financial institutions, and/or third party shippers, described herein.

The database 50H can also contain user identification information which can include, but which is not limited to, individual, user, or merchant information, account number information, name information, address information, e-mail address information, merchant site membership information, password(s) and/or password information, URL information, memory jogger information, and cookie information.

The database 50H can also contain tracking information which can include shipping tracking information, shipment tracking identification number information, transaction identification information, transaction city, state, country and zip code, shipping company and/or carrier information, shipper and/or merchant information which can include, but which is not limited to, identification number, name of shipping party, and address information of shipping party or shipping parties, including address, city, state, country and zip code, identification number information, delivery information which can include, but which is not limited to, account number information, name of receiving party or receiving parties, address information of receiving party, including address, city, state, country and zip code.

The database 50H can also contain transaction information which can include, but which is not limited to, transaction identification number, merchant identification number information, transaction dates, activity dates, goods, products, items, and/or services, purchased, information regarding purchase amounts, information regarding shipping costs, and information regarding sales taxes.

The database 50H can also contain security information which can include, but which is not limited to, password(s) and/or password information, barcode information, card reader information, magnetic strip information, fingerprint scanner/reader information, retinal scanning information, palm print scanner/reader information, and voice recognition information.

The database 50H can also contain security and/or password information which can include, but which is not limited tom user account number information, web site information, user log-on and/or log-in information, password(s) and/or password information, memory jogger information, vendor identification information, and customer identification information.

The database 50H can also contain returned goods information which can include, but which is not limited to, transaction identification information, transaction identification number information, user identification number information, transaction date information, activity date information, merchant identification information, merchant identification number information, refund information, credit information, shipped back information, shipped back date information, and shipper information and/or carrier information.

The database 50H can also contain shipping rate information which can include rate information for shipping from a certain zip code(s) to a certain zip code(s), carrier rate information, next-day delivery information, 2^{nd} day delivery information, 3^{rd} day delivery information, ground delivery information, air delivery information and/or sea delivery information.

The database 50H can also contain information regarding any and all applicable country, state, county, and/or local, taxes, duties, tariffs, import fees, export fees, customs charges, and/or any other applicable taxes, fees and/or charges.

The database 50H can also contain any of the information described herein as being stored in the respective databases of the central processing computers 10, the user computers 20, the provider computers 30, the shipper computers 40, the third party shipper computers 60, and/or any of the other financial institution computers 50.

The database 50H can also contain any data, information, software programs, and/or software algorithms, which can be needed and/or desired for performing the processing routines and/or functions described herein. The database 50H can also contain any suitable software for allowing the financial institution computer 50 to access, and/or perform transactions with, the central processing computer(s) 10 and/or any of the other user computers 20, provider computers 30, shipper computers 40, financial institution computers 50, and/or third party shipper computers 60, described herein. The database 50H can also contain any suitable software for allowing any of the central processing computer(s) operators, users, providers, shippers, financial institutions, and/or third party shippers, to access the financial institution computers 50 and/or perform transactions with the financial institution computers 50 via the respective central processing computer(s) 10, user computer(s) 20, provider computer(s) 30, shipper computer(s) 40, financial institution computer(s) 50, and/or third party shipper computer(s) 60, and/or from any other computer or communication device having access to the communication network on or over which the apparatus 100 can operate.

With reference once again to FIG. 6, the financial institution computer 50 also includes an output device 50I such as a printer, a modem, a fax/modem, or other output device, for providing data and/or information to the operator or user of the financial institution computer 50 or to a third party or third party entity.

The financial institution computer 50 can also include any other hardware and/or software for facilitating the operation of the financial institution computer 50 as described herein.

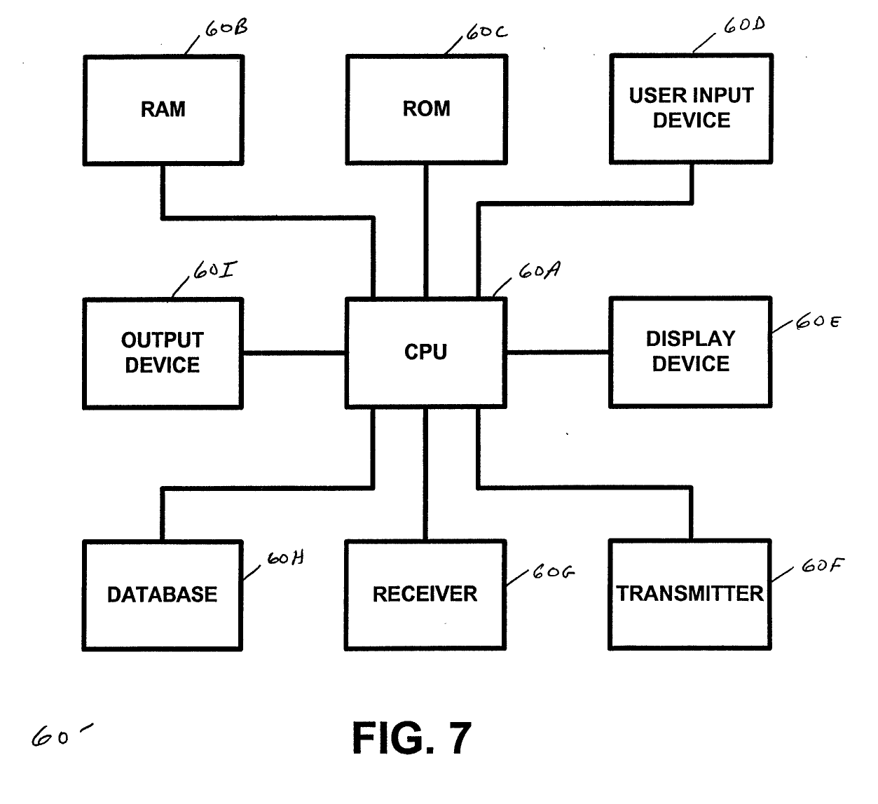

FIG. 7 illustrates the third party shipper computer 60, in block diagram form. The third party shipper computer 60, in the preferred embodiment, can be a computer, personal computer, or communication device, described herein, and/or any other suitable or appropriate computer and/or communication device which can be utilized as a third party shipper computer. In the preferred embodiment, the third party shipper computer 60 includes a central processing unit or CPU 60A, which in the preferred embodiment, is a microprocessor. The CPU 60A may also be a microcomputer, a minicomputer, a macro-computer, and/or a mainframe computer, depending upon the application.

The third party shipper computer 60 also includes a random access memory device(s) 60B (RAM) and a read only memory device(s) 60C (ROM), each of which is connected to the CPU 60A, a user input device 60D, for entering data and/or commands into the third party shipper computer 60, which includes any one or more of a keyboard, a scanner, a user pointing device, such as, for example, a mouse, a touch pad, a bio-metric devices(s), such as a voice recognition device, a retinal scanning device, a fingerprint recognition device, a barcode reader, a card reader, etc., if desired, which input device(s) are also connected to the CPU 60A. The third party shipper computer 60 also includes a display device 60E for displaying data and/or information to a user or operator.

The third party shipper computer 60 also includes a transmitter(s) 60F, for transmitting signals and/or data and/or information to any one or more of the central processing computers 10, the user computers 20, the provider computers 30, the shipper computers 40, the financial institution computers 50, and/or to any other third party shipper computer(s) 60, which may be utilized in conjunction with the present invention. The third party shipper computer 60 also includes a receiver 60G, for receiving signals and/or data and/or information from any one or more of central processing computers 10, the user computers 20, the provider computers 30, the shipper computers 40, the financial institution computers 50, and/or to any other third party shipper computer(s) 60.

The third party shipper computer 60 also includes a database(s) 60H which contains data and/or information pertaining to any of the users, operators, providers, shipping service providers, and financial institutions, who or which utilize the apparatus and method of the present invention. The database 60H can include any data and/or information needed and/or desired for performing any of the functions and/or services described herein as being provided by the apparatus and method of the present invention.

The database 60H can contain, for example, name, address, phone number, facsimile number, e-mail address, and/or any other information regarding any of the individuals, users, providers, shippers, financial institutions, and/or third party shippers, described herein.

The database 60H can also contain user identification information which can include, but which is not limited to, individual, user, or merchant information, account number information, name information, address information, e-mail address information, merchant site membership information, password(s) and/or password information, URL information, memory jogger information, and cookie information.

The database 60H can also contain tracking information which can include shipping tracking information, shipment tracking identification number information, transaction identification information, transaction city, state, country and zip code, shipping company and/or carrier information, shipper and/or merchant information which can include, but which is not limited to, identification number, name of shipping party, and address information of shipping party or shipping parties, including address, city, state, country and zip code, identification number information, delivery information which can include, but which is not limited to, account number information, name of receiving party or receiving parties, address information of receiving party, including address, city, state, country and zip code.

The database 60H can also contain transaction information which can include, but which is not limited to, transaction identification number, merchant identification number information, transaction dates, activity dates, goods, products, items, and/or services, purchased, information regarding purchase amounts, information regarding shipping costs, and information regarding sales taxes.

The database 60H can also contain security information which can include, but which is not limited to, password(s) and/or password information, barcode information, card reader information, magnetic strip information, fingerprint scanner/reader information, retinal scanning information, palm print scanner/reader information, and voice recognition information.

The database 60H can also contain security and/or password information which can include, but which is not limited tom user account number information, web site information, user log-on and/or log-in information, password(s) and/or password information, memory jogger information, vendor identification information, and customer identification information.

The database 60H can also contain any information and/or data for decoding, decrypting, and/or deciphering, any label(s) and/or shipping information in order to provide for the anonymous shipping services described herein.

The database 60H can also contain returned goods information which can include, but which is not limited to, transaction identification information, transaction identification number information, user identification number information, transaction date information, activity date information, merchant identification information, merchant identification number information, refund information, credit information, shipped back information, shipped back date information, and shipper information and/or carrier information.

The database 60H can also contain shipping rate information which can include rate information for shipping from a certain zip code(s) to a certain zip code(s), carrier rate information, next-day delivery information, 2^{nd} day delivery information, 3^{rd} day delivery information, ground delivery information, air delivery information and/or sea delivery information.

The database 60H can also contain information regarding any and all applicable country, state, county, and/or local, taxes, duties, tariffs, import fees, export fees, customs charges, and/or any other applicable taxes, fees and/or charges.

The database 60H can also contain any of the information described herein as being stored in the respective databases of the central processing computers 10, the user computers 20, the provider computers 30, the shipper computers 40, the financial institution computers 50, and/or any of the third party shipper computers 60.

The database 60H can also contain any data, information, software programs, and/or software algorithms, which can be needed and/or desired for performing the processing routines and/or functions described herein. The database 60H can also contain any suitable software for allowing the third party shipper computer 60 to access, and/or perform transactions with, the central processing computer(s) 10 and/or any of the other user computers 20, provider computers 30, shipper computers 40, financial institution computers 50, and/or third party shipper computers 60, described herein. The database 60H can also contain any suitable software for allowing any of the central processing computer(s) operators, users, providers, shippers, financial institutions, and/or third party shippers, to access the third party shipper computers 60 and/or perform transactions with the third party shipper computers 60 via the respective central processing computer(s) 10, user computer(s) 20, provider computer(s) 30, shipper computer(s) 40, financial institution computer(s) 50, and/or third party shipper computer(s) 60, and/or from any other computer or communication device having access to the communication network on or over which the apparatus 100 can operate.

With reference once again to FIG. 7, the third party shipper computer 60 also includes an output device 60I such as a printer, a modem, a fax/modem, or other output device, for providing data and/or information to the operator or user of the third party shipper computer 60 or to a third party or third party entity.

The third party shipper computer 60 can also include any other hardware and/or software for facilitating the operation of the third party shipper computer 60 as described herein.

In another preferred embodiment, the central processing computer 10 can perform the functions of a financial institution. In this manner, the central processing computer 10 can process any and/or all of the financial transactions which may occur, and/or which may be incidental to, the operation or the utilization of the apparatus and method of the present invention.

In another preferred embodiment, the apparatus and method of the present invention can be utilized in conjunction with a warehouse facility which can be operated by and/or in conjunction with any of the providers, provider computers 30, shippers, shipper computers 40, financial institutions, financial institution computers 50, third party shippers, and/or third party shipper computers 60, which are described herein.

The apparatus and method of the present invention can be utilized, in a preferred embodiment, in order to facilitate and/or provide for the anonymous shipment of goods, products, and/or services. The present invention can be utilized by a user to make a purchase of goods, products, and/or services, and arrange for the anonymous shipment of the respective goods, products, and/or services so as to conceal the user's identity and shipment address from the provider. In this manner, the apparatus and method of the present invention provides for anonymous shipping services.

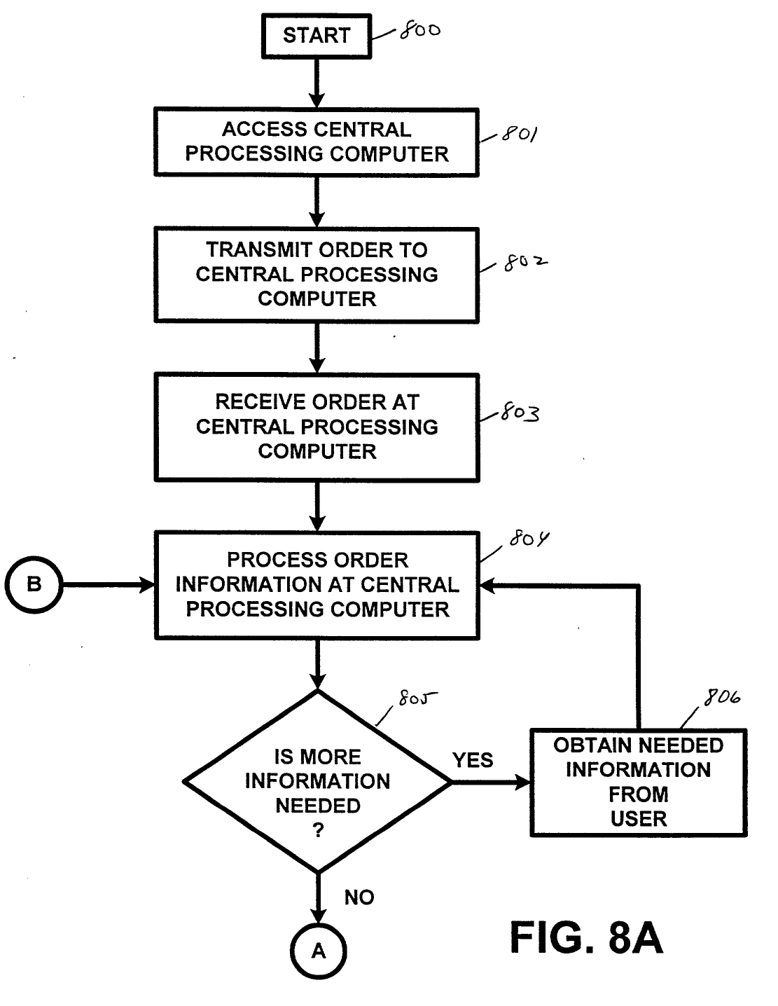

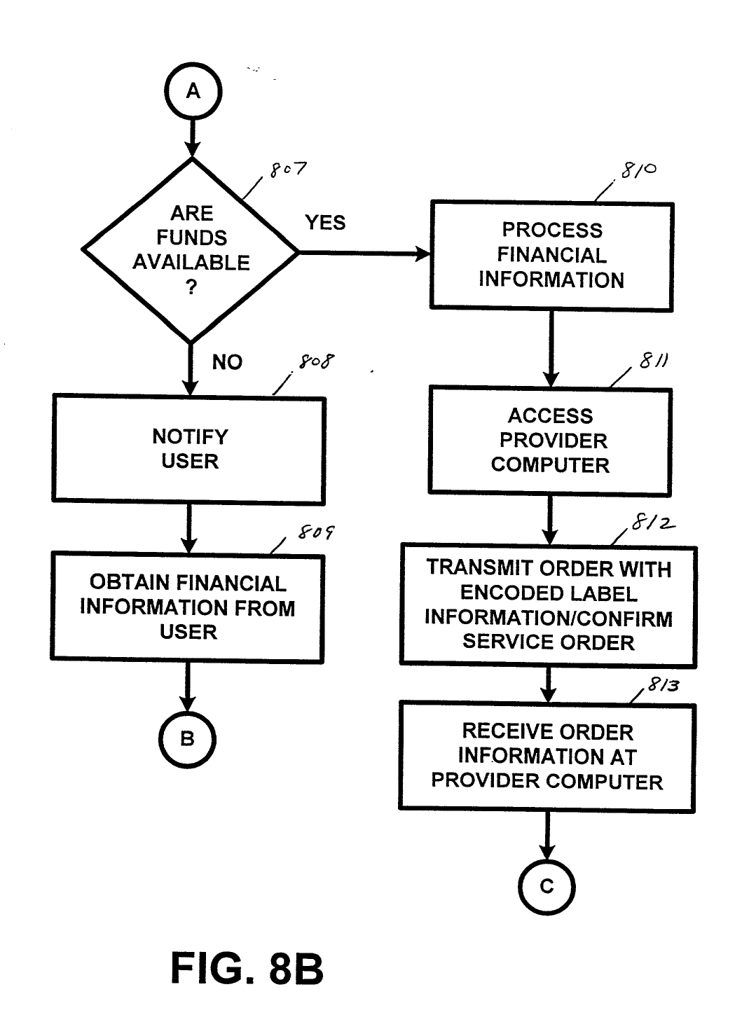

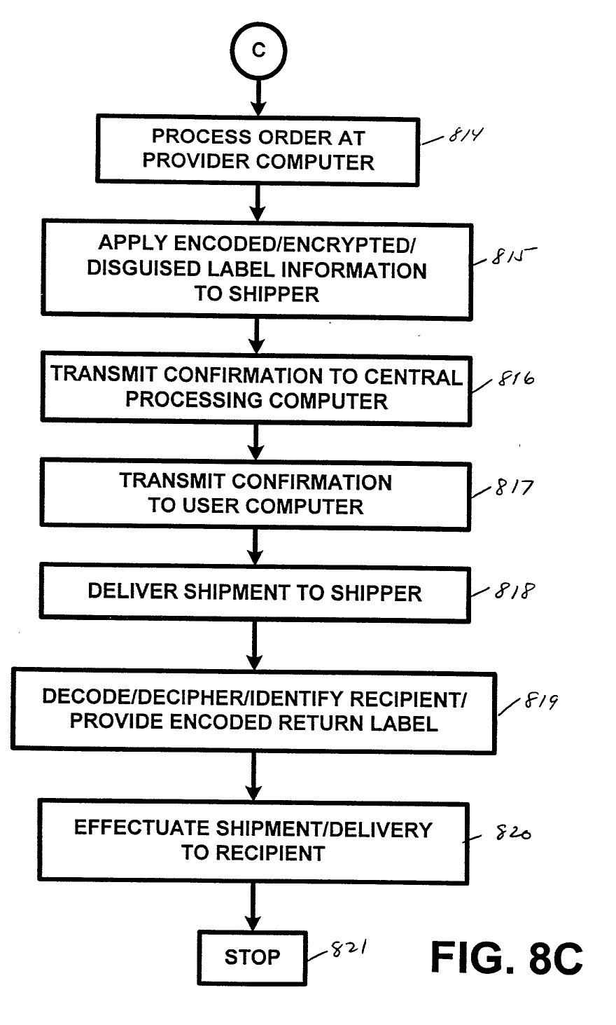

FIGS. 8A, 8B, and 8C illustrate a preferred embodiment method for utilizing the apparatus and method of the present invention, in flow diagram form. With reference to FIGS. 8A, 8B, and 8C, the operation of the apparatus 100 commences at step 800. At step 801, the user accesses the central processing computer 10 via the user's user computer 20. At step 801, the user may enter identification information, a security code or password and/or any other information in order to gain access to the central processing computer 10. Users may register with the central processing computer 10 at any time prior session and/or during a current session.

At step 802, the user may request information for, and/or view offerings of, various goods, products, and/or services via the user computer 20. At step 802, the user can transmit an order for any respective good, product, and/or service. The order, along with any other information related to the transaction, can be provided in or via any of the respective forms which can be stored at or provided by the central processing computer.

At step 802, the order is transmitted from the user computer 20 to the central processing computer 10. At step 803, the central processing computer 10 receives the user's order. At step 804, the central processing computer 10 processes the user's order. At step 804, the central processing computer 10 will also process financial information regarding the user's order.

At step 805, the central processing computer 10 will determine whether any additional information is needed in order to process the user's order and/or the financial transaction corresponding to the order. If, at step 805, it is determined that more information is needed from the user, the central processing computer 10 will proceed to step 806 and obtain the needed information from the user. Thereafter, the operation of the central processing computer 10 will proceed to step 804 and the additional information will be processed in conjunction with the information already provided by the user. The operation will then proceed to step 805.

If, however, at step 805, it is determined that no additional information is needed, the operation of the central processing computer 10 will proceed to step 807 and the central processing computer 10 will determine if funds are available to satisfy the financial transaction relating to the user's order. The central processing computer 10 may access the financial institution computer 50 in order to process any financial transactions described herein and/or to determine if sufficient funds are available in the user's account.

If, at step 807, it is determined than no funds or insufficient funds are available, then the central processing computer will, at step 808, transmit a notification message to the user notifying the user of the insufficient funds status of his or her account. Thereafter, at step 809, the central processing computer will obtain any funds and/or information for securing additional funds from the user. Thereafter, the operation of the apparatus will proceed to step 804 and the obtained information will be processed as described above.

If, at step 807, the central processing computer 10 determines that sufficient funds are available, then the operation of the apparatus 100 will proceed to step 810 and the central processing computer 10 will process the financial information relating to the order. The financial information which is processed at step 810 can include credit card information, credit account information, charge card information, charge account information, debit card information, debit account information, financial account information, checking account information, savings account information, electronic funds transfer information, and/or any other financial account information.

At step 811, the central processing computer 10 will access the provider computer 30 associated with the goods, products, and/or services, which are the subject of the user's order. At step 812, the central processing computer 10 will transmit the user's order to the provider computer while concealing the user's identity and delivery address from the provider computer 30.

At step 812, the central processing computer will also transmit encoded shipping information, an encoded shipping label, encrypted shipping information, an encrypted shipping label, and/or shipping information and/or a shipping label which disguises the user's or the recipient's identity and user's or the recipient's shipping address, and/or information related thereto. At step 813, the provider computer 30 will receive the order information along with the encoded shipping label, the encrypted shipping label, and/or the shipping label which disguises the user's identity and shipping address, and/or the information related thereto.

At step 814, the provider computer 30 will process the user's order and the information obtained at step 813. At step 815, the provider computer 30 will apply or affix a label, a code, and/or other information containing the encoded label information, the encrypted label information, and/or the information disguising the user's identity and shipping address (hereinafter referred to at the “anonymous shipping label information), to the package containing the goods or products which are the subject of the order. In the case of services, the services and/or information regarding the services can be provided to the central processing computer at step 815 with the services and/or information regarding the services relayed to the user computer 20 via the central processing computer 10.

At step 816, the provider computer 30 will transmit a message to the central processing computer 10 confirming the fulfillment of the user's order. The central processing computer 10 will thereafter, at step 817, transmit a confirmation message to the user computer 20 thereby providing the order fulfillment confirmation to the user.

At step 818, the package containing the anonymous shipping label information is transmitted, sent, or shipped to the shipper. In another preferred embodiment, the package containing the anonymous shipping label information is transmitted, sent, or shipped to the third party shipper or shipping warehouse. In the case of a third party shipper or a shipping warehouse, the operation of the apparatus will proceed in a similar and/or analogous manner as in the case of utilizing a shipper.

At step 819, the shipper will receive the package. At step 819, the shipper or operator of the shipping computer 40 will decode, decipher, and/or otherwise determine or ascertain the identify of the user or recipient and/or the user's or the recipient's shipping address from the encoded label information, the encrypted label information, and/or the information disguising the user and the user's and the user's shipping address, and/or any other information related thereto.

The shipper computer 40 will, at step 819, also print out or otherwise provide, apply, and/or affix a shipping label, identifying the user(s) or the recipient(s) and the address to which the package is to be shipped. At step 819, the shipper computer 40 will process return label information correlating the identity of the user or the recipient, and/or the user's or the recipient's address with the provider of the goods or products and the provider's return address information.

The shipper computer 40, will thereafter, at step 819, store this information in its database 40H. The shipper computer 40 can also, at step 819, also provide return label information for return of the package to the provider, the shipper, or the third party shipper. All of the address information for the package, the shipper and the provider will be correlated for the shipping transaction and stored in the database 40H.

At step 819, the shipper computer will also provide the return shipping information to the package for later use and correlation by the shipper computer 40 in the event the goods or products are returned. The return shipping information can be affixed or applied to the package or can be provided on a separate return shipping label or other return information document(s).

Thereafter, at step 820, the shipper can effectuate the delivery of the package to the user or recipient. Thereafter, the operation of the apparatus 100 will cease at step 821.

In the event that the package must be returned to the provider, the user or recipient can ship or send the package to the shipper. The shipper can thereafter, utilize the information provided on the return shipping label and/or in the return shipping information provided on or in the respective documents. The shipper can thereafter utilize the shipper computer 40 in order to correlate the package with the address of the provider and can thereafter provide a return shipping label to the package and effectuate the return shipment to the provider. The return shipment label or other information can also include the encoded label information, the encrypted label information and or the information disguising the user or recipient and/or any other related information. Thereafter, the provider computer can identify the transaction and, thereafter, perform any corrective measures (i.e. provide a credit, charge-back, or refund operation, or re-ship another good or product to the user or recipient).

Any of the corrective measures and/or information related thereto can be effectuated in conjunction with information obtained via the return shipping information and/or via the central processing computer 10, or via both.

In the above manner, the apparatus and method of the present invention can provide for the anonymous shipment of goods, products, and/or services.

In another preferred embodiment, the third party shipper computer 60 can be utilized in the same manner as the shipper computer 40 in order to effectuate the above-described processing and/or servicing functions. In the case of a shipping warehouse, a third party shipper computer 60 can be utilized as a warehouse computer for performing all of the herein-described processing and/or servicing functions.

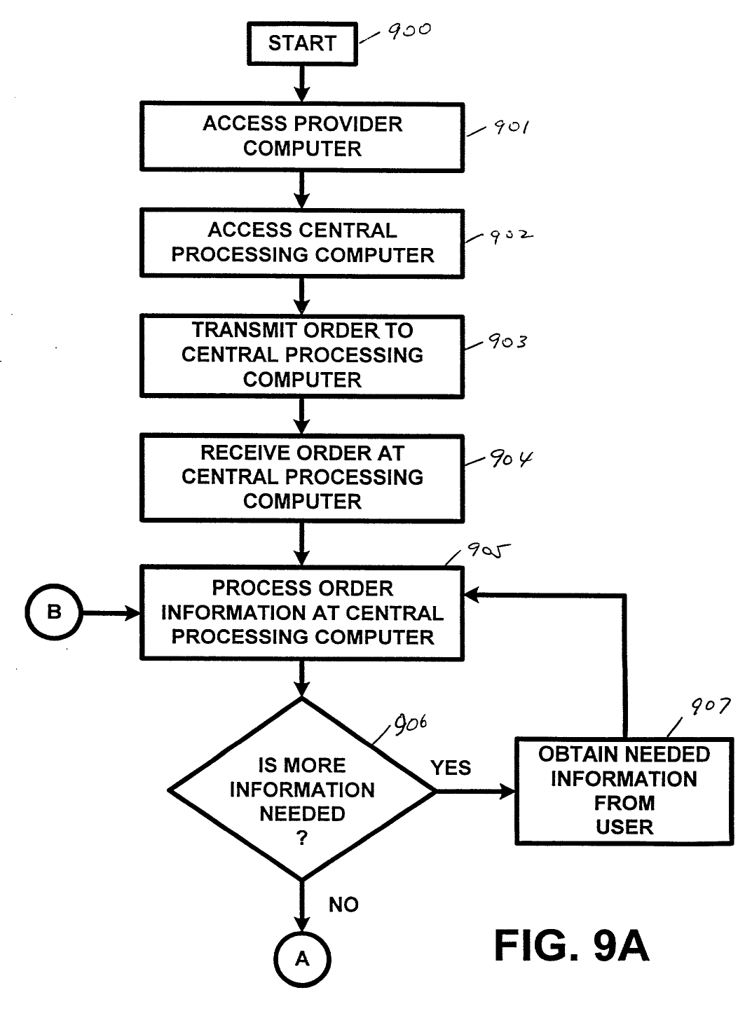

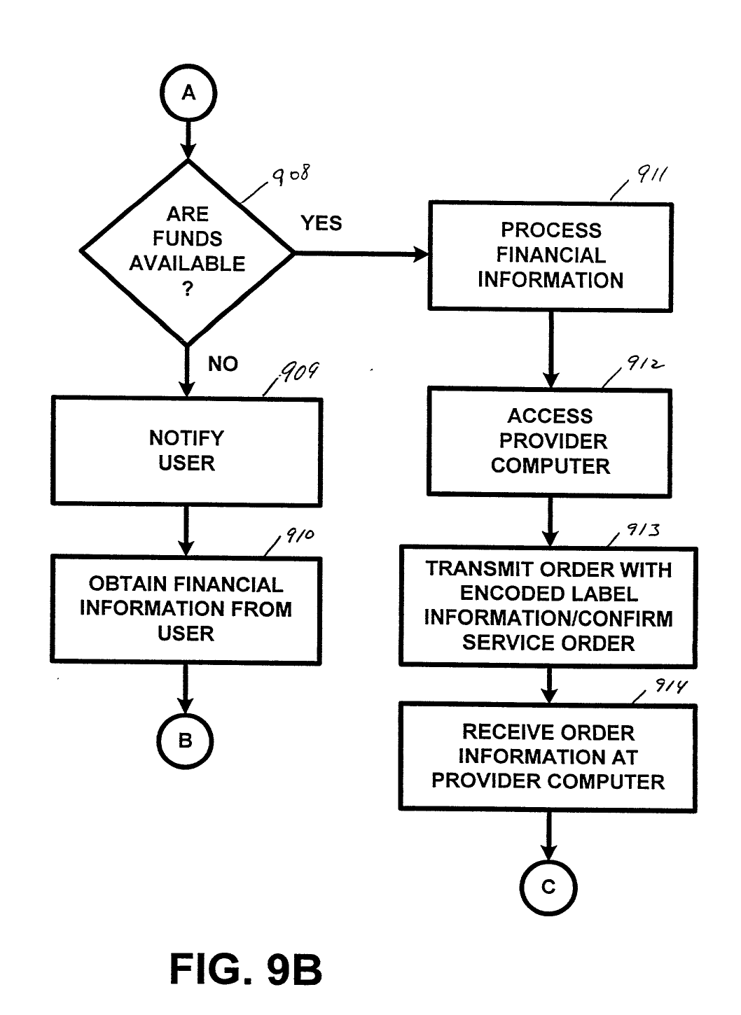

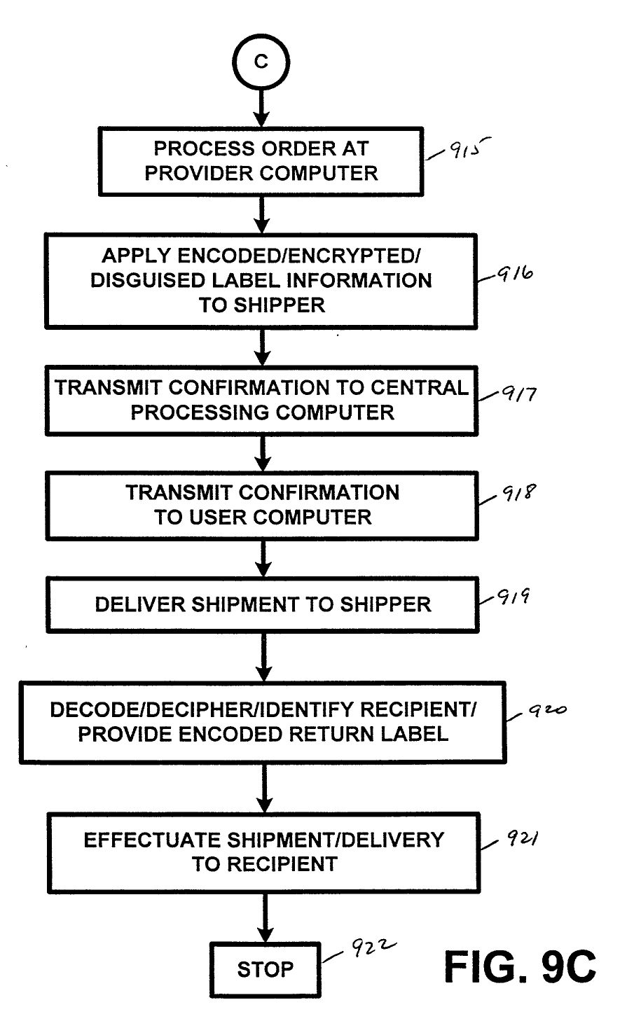

In another preferred embodiment, the apparatus and method of the present invention can be utilized in order to provide anonymous shipping services subsequent to a user obtaining information from a provider or from a provider computer 30. For example, a user may obtain information from a provider computer 30 and thereafter make the decision to purchase a good, a product, and/or a service, while desiring to remain anonymous to the provider or to the provider computer 30. FIGS. 9A, 9B, and 9C illustrate another preferred embodiment method of utilizing the apparatus and method of the present invention, in flow diagram form.

With reference to FIGS. 9A, 9B, and 9C, the operation of the apparatus 100 commences at step 900. At step 901, the user accesses the provider computer 30 and obtains information therefrom. At step 901, the user also makes the decision to purchase a good, a product, and/or a service, from the provider, but decides to do so anonymously. Thereafter, the user terminates the connection from the provider computer 30. At step 902, the user accesses the central processing computer 10 via the user's user computer 20.

At step 902, the user may enter identification information, a security code or password and/or any other information in order to gain access to the central processing computer 10. As described above, users may register with the central processing computer 10 at any time during a prior session and/or during a current session.

At step 903, the user may request information for, and/or view offerings of, various goods, products, and/or services via the user computer 20. At step 903, the user can transmit an order for any respective good, product, and/or service. The order, along with any other information related to the transaction, can be provided in or via any of the respective forms which can be stored at or provided by the central processing computer 10 and/or any of the respective computers of any of the herein-described providers, shippers, financial institutions, and/or third party shippers, who or which utilize the apparatus 100. At step 903, the order is transmitted from the user computer 20 to the central processing computer 10.

At step 904, the central processing computer 10 receives the user's order. At step 905, the central processing computer 10 processes the user's order. At step 905, the central processing computer 10 will also process financial information regarding the user's order.

At step 906, the central processing computer 10 will determine whether any additional information is needed in order to process the user's order and/or the financial transaction corresponding to the order. If, at step 906, it is determined that more information is needed from the user, the central processing computer will proceed to step 907 and obtain the needed information from the user. Thereafter, the operation of the central processing computer 10 will proceed to step 905 and the additional information will be processed in conjunction with the information already provided by the user. The operation will then proceed to step 906.

If, however, at step 906, it is determined that no additional information is needed, the operation of the central processing computer 10 will proceed to step 908 and the central processing computer 10 will determine if funds are available to satisfy the financial transaction relating to the user's order. The central processing computer 10 may access the financial institution computer 50 in order to process any financial transactions described herein and/or to determine if sufficient funds are available in the user's account.

If, at step 908, it is determined than no funds or insufficient funds are available, then the central processing computer will, at step 909, transmit a notification message to the user notifying the user of the insufficient funds status of his or her account. Thereafter, at step 910, the central processing computer 10 will obtain any funds and/or information for securing additional funds from the user. Thereafter, the operation of the apparatus 100 will proceed to step 905 and the obtained information will be processed as described above.

If, at step 908, the central processing computer 10 determines that sufficient funds are available, then the operation of the apparatus 100 will proceed to step 911 and the central processing computer 10 will process the financial information relating to the order. The financial information which is processed at step 911 can include credit card information, credit account information, charge card information, charge account information, debit card information, debit account information, financial account information, checking account information, savings account information, electronic funds transfer information, and/or any other financial account information.

At step 912, the central processing computer 10 will access the provider computer 30 associated with the goods, products, and/or services, which are the subject of the user's order. At step 913, the central processing computer 10 will transmit the user's order to the provider computer 30 while concealing the user's identity and delivery address from the provider computer 30.

At step 913, the central processing computer 10 will also transmit encoded shipping information, an encoded shipping label, encrypted shipping information, an encrypted shipping label, and/or shipping information and/or a shipping label which disguises the user's or the recipient's identity and user's or the recipient's shipping address, and/or information related thereto. At step 914, the provider computer 30 will receive the order information along with the encoded shipping label, the encrypted shipping label, and/or the shipping label which disguises the user's identity and shipping address, and/or the information related thereto.

At step 915, the provider computer 30 will process the user's order and the information obtained at step 914. At step 916, the provider computer 30 will apply or affix a label, a code, and/or other information containing the encoded label information, the encrypted label information, and/or the information disguising the user's identity and shipping address (hereinafter referred to at the “anonymous shipping label information), to the package containing the goods or products which are the subject of the order. In the case of services, the services and/or information regarding the services can be provided to the central processing computer at step 916 with the services and/or information regarding the services relayed to the user computer 20 via the central processing computer 10.

At step 917, the provider computer 30 will transmit a message to the central processing computer 10 confirming the fulfillment of the user's order. The central processing computer 10 will thereafter, at step 918, transmit a confirmation message to the user computer 20 thereby providing the order fulfillment confirmation to the user.

At step 919, the package containing the anonymous shipping label information is transmitted, sent, or shipped to the shipper. In another preferred embodiment, the package containing the anonymous shipping label information is transmitted, sent, or shipped to the third party shipper or shipping warehouse. In the case of a third party shipper or a shipping warehouse, the operation of the apparatus will proceed in a similar and/or analogous manner as in the case of utilizing a shipper.

At step 920, the shipper will receive the package. At step 920, the shipper or operator of the shipping computer 40 will decode, decipher, and/or otherwise determine or ascertain the identify of the user or recipient and/or the user's or the recipient's shipping address from the encoded label information, the encrypted label information, and/or the information disguising the user and the user's and the user's shipping address, and/or any other information related thereto.

The shipper computer 40 will, at step 920, also print out or otherwise provide, apply, and/or affix, a shipping label, identifying the user(s) or the recipient(s) and the address to which the package is to be shipped. At step 920, the shipper computer 40 will process return label information correlating the identity of the user or the recipient, and/or the user's or the recipient's address with the provider of the goods or products and the provider's return address information. The shipper computer 40, will thereafter, at step 920, store this information in its database 40H. The shipper computer 40 can also, at step 920, also provide return label information for return of the package to itself. All of the address information for the package, the shipper and the provider will be correlated for the shipping transaction and stored in the database 40H.

At step 920, the shipper computer will also provide the return shipping information to the package for later use and correlation by the shipper computer 40 in the event the goods or products are returned. The return shipping information can be affixed or applied to the package or can be provided on a separate return shipping label or other return information document(s).

Thereafter, at step 921, the shipper can effectuate the delivery of the package to the user or recipient. Thereafter, the operation of the apparatus 100 will cease at step 922.

In the event that the package must be returned to the provider, the user or recipient can ship or send the package to the shipper and the return shipping process described herein-above with regards to the preferred embodiment of FIGS. 9A, 9B, and 9C can be performed in order to effectuate an anonymous return from the user or recipient.

In the above-described manner, the apparatus and method of the present invention can utilized in order to effectuate an anonymous shipment subsequent to a user's interaction and/or accessing of a provider computer 30.

In another preferred embodiment, the apparatus and method of the present invention can also be utilized by dispensing with the processing of any financial transactions such as in instances when goods, products, and/or services may be offered for free or in no-payment scenarios. In these embodiments, the operation of the apparatus and method of the present invention can be easily modified so as to dispense with the processing of any financial transactions.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. An apparatus for facilitating an anonymous shipment, comprising:
a memory device for storing information regarding the identity and shipping address for at least one individual;
a receiver for receiving an order for at least one of a good and a service;
a processor for processing the order for said at least one of a good and a service, wherein said processor generates an order message, wherein said order message contains a shipping message containing at least one of an anonymous shipping address information, an encoded shipping address information, an encrypted shipping address information, and a disguised shipping address information, wherein said shipping message conceals the address of an individual who at least one of placed the order and is to receive the shipment; and
a transmitter for transmitting said order message to a provider of at least one of goods and services for order fulfillment.

2. The apparatus of claim 1, wherein said processor determines whether sufficient information has been received to place the order.

3. The apparatus of claim 1, wherein said processor determines whether sufficient funds are available to place the order.

4. The apparatus of claim 1, wherein said processor processes an order confirmation message, and further wherein said transmitter transmits said order confirmation message to the individual who at least one of placed the order and is to receive the shipment.

5. A method for facilitating an anonymous shipment, comprising:
storing information regarding the identity and shipping address for at least one individual;
receiving an order for at least one of a good and a service;
processing the order for said at least one of a good and a service;
generating an order message, wherein said order message contains a shipping message containing at least one of an anonymous shipping address information, an encoded shipping address information, an encrypted shipping address information, and a disguised shipping address information, wherein said shipping message conceals the address of an individual who at least one of placed the order and is to receive the shipment; and
transmitting said order message to a provider of at least one of goods and services for order fulfillment.

6. The method of claim 5, further comprising:
determining whether sufficient information has been received to place the order.

7. The method of claim 5, further comprising:
determining whether sufficient funds are available to place the order.

8. The method of claim 5, further comprising:
processing an order confirmation message; and
transmitting said order confirmation message to the individual who at least one of placed the order and is to receive the shipment.

9. An apparatus for facilitating an anonymous shipment, comprising:
a memory device for storing information for processing a transaction;
a receiver for receiving an order for at least one of a good and a service; and
a processor for processing the order for said at least one of a good and a service, wherein said processor generates a shipping label, wherein said shipping label contains at least one of an anonymous shipping address information, an encoded shipping address information, an encrypted shipping address information, and a disguised shipping address information, wherein said shipping label conceals the address of an individual who at least one of placed the order and is to receive the shipment.

10. The apparatus of claim 9, further comprising:
a transmitter, wherein said processor generates an order confirmation message, and further wherein said transmitter transmits said order confirmation message to a communication device associated with at least one of a central processing center and a an individual who at least one of placed the order and is to receive the shipment.

11. The apparatus of claim 9, wherein said processor processes information regarding at least one of a return shipment, a return of at least one of goods and services, an exchange of at least one of goods and services, and a refund for an order.
